(19) United States
(12) Patent Application Publication
(10) Pub. No.: US 2024/0114500 A1
(43) Pub. Date: Apr. 4, 2024

(54) COLLISION HANDLING FOR SUBBAND FULL DUPLEX AWARE USER EQUIPMENTS

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Abdelrahman Mohamed Ahmed Mohamed IBRAHIM, San Diego, CA (US); Yan ZHOU, San Diego, CA (US)

(21) Appl. No.: 18/457,451

(22) Filed: Aug. 29, 2023

Related U.S. Application Data
(60) Provisional application No. 63/412,263, filed on Sep. 30, 2022.

(51) Int. Cl. H04W 72/12; H04L 5/14; H04W 72/232; H04W 74/08

(52) U.S. Cl. CPC H04W 72/12; H04L 5/14; H04W 72/232; H04W 74/0808

(57) ABSTRACT

Methods, systems, and devices for wireless communications are described. A network entity may implement a subband full duplex communication scheme. For a half duplex UE, each slot may be configured as either a downlink slot or an uplink slot. A half duplex UE may be scheduled with a transmission in a conflicting (e.g., opposite) direction with respect to the configured slot direction for the UE. The UE may determine whether to communicate a scheduled transmission in a conflicting direction of the configured slot direction in accordance with a conflict resolution scheme. A UE may receive scheduling information for a second transmission that is scheduled for the same direction as the slot in addition to the transmission scheduled for the opposite direction as the slot. The UE may apply the conflict resolution scheme to determine which transmission to communicate.

### CROSS REFERENCE

The present application for patent claims the benefit of U.S. Provisional Patent Application No. 63/412,263 by ABDELGHAFFAR et al., entitled “COLLISION HANDLING FOR SUBBAND FULL DUPLEX AWARE USER EQUIPMENTS,” filed Sep. 30, 2022, and assigned to the assignee hereof. U.S. Provisional Patent Application No. 63/412,263 is expressly incorporated by reference herein in its entirety.

### INTRODUCTION

The following relates to wireless communications relating to collision handling for subband full duplex aware user equipments (UE)s.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as UE.

### SUMMARY

The described techniques relate to improved methods, systems, devices, and apparatuses that support collision handling for subband full duplex (SBFD) aware user equipments (UEs). For example, the described techniques provide for conflict resolution for a scheduled transmission for a UE in a conflicting direction as a configured direction of a time interval (e.g., a slot or symbol) for the UE. In some wireless communication systems, a network entity may implement a SBFD communication scheme. A half duplex UE may transmit uplink communications or may receive downlink communications in a given time resource, but a half duplex UE is not capable of transmitting and receiving simultaneously in the same time resource. Each slot for a half duplex UE may be indicated or configured as either a downlink slot, an uplink slot, or a flexible slot. An SBFD aware half duplex UE may be scheduled (e.g., either dynamically via downlink control information (DCI) or via higher layer semi-static scheduling (such as radio resource control (RRC)) with a transmission in a conflicting (e.g., opposite) direction with respect to the configured or indicated slot direction for the half duplex UE. For example, an SBFD aware half duplex UE may be scheduled for an uplink transmission in a slot configured as a downlink slot for the half duplex UE (using the uplink subband(s) for that slot) or a downlink transmission in a slot configured as an uplink slot for the half duplex UE (using the downlink subband(s) for that slot). A half duplex UE may determine whether to communicate a scheduled transmission in a conflicting direction of the configured time interval (e.g., slot) direction for the half duplex UE (where the slot is an SBFD slot for the network entity) in accordance with a conflict resolution scheme. In some aspects, a half duplex UE may receive scheduling information for a second transmission in a slot that is scheduled for the same direction as the slot in addition to the transmission in the slot scheduled for a opposite direction as the slot. The UE may apply the conflict resolution scheme to determine whether to communicate the transmission in the opposite direction of the slot or the second transmission in the same direction as the slot.

A method for wireless communications at a first network entity is described. The method may include receiving control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network entity, receiving scheduling information for a first transmission between the first network entity and the second network entity in the time interval and the second set of frequency resources for the time interval, where the scheduling information includes an indication that the first transmission is associated with the second communication direction, and communicate with the second network entity via the time interval in accordance with a conflict resolution scheme based on the time interval being associated with the first communication direction and the first transmission being associated with the second communication direction.

A first network entity for wireless communications. The first network entity may include at least one communications interface, and at least one processor coupled to the at least one communications interface. The first network entity may be configured to receive control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network entity, receive scheduling information for a first transmission between the first network entity and the second network entity in the time interval and the second set of frequency resources for the time interval, where the scheduling information includes an indication that the first transmission is associated with the second communication direction, and communicate with the second network entity via the time interval in accordance with a conflict resolution scheme based on the time interval being associated with the first communication direction and the first transmission being associated with the second communication direction.

Another apparatus for wireless communications at a first network entity is described. The apparatus may include means for receiving control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network entity, means for receiving scheduling information for a first transmission between the first network entity and the second network entity in the time interval and the second set of frequency resources for the time interval, where the scheduling information includes an indication that the first transmission is associated with the second communication direction, and means for communicate with the second network entity via the time interval in accordance with a conflict resolution scheme based on the time interval being associated with the first communication direction and the first transmission being associated with the second communication direction.

A non-transitory computer-readable medium having code for wireless communications stored thereon is described. The code, when executed by a first network entity, causes the first network entity receive control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network entity, receive scheduling information for a first transmission between the first network entity and the second network entity in the time interval and the second set of frequency resources for the time interval, where the scheduling information includes an indication that the first transmission is associated with the second communication direction, and communicate with the second network entity via the time interval in accordance with a conflict resolution scheme based on the time interval being associated with the first communication direction and the first transmission being associated with the second communication direction.

In some examples of the method, apparatuses, and non-transitory computer-readable medium described herein, communicating with the second network entity via the time interval may include operations, features, means, or instructions for communicating, in accordance with the conflict resolution scheme, the first transmission via the time interval and the second set of frequency resources.

In some examples of the method, apparatuses, and non-transitory computer-readable medium described herein, the time interval includes a flexible time interval type based on the first transmission being associated with the second communication direction in accordance with the conflict resolution scheme and communicating the first transmission via the time interval and the second set of frequency resources may be based on the time interval including the flexible time interval type.

Some examples of the method, apparatuses, and non-transitory computer-readable medium described herein may further include operations, features, means, or instructions for communicating, in accordance with the conflict resolution scheme, the first transmission via the time interval and the second set of frequency resources based on a DCI including the scheduling information, where receiving the scheduling information includes receiving the DCI including the scheduling information.

Some examples of the method, apparatuses, and non-transitory computer-readable medium described herein may further include operations, features, means, or instructions for receiving second scheduling information for a second transmission between the first network entity and the second network entity in the time interval and the first set of frequency resources for the time interval, where the second scheduling information includes an indication that the second transmission may be associated with the first communication direction, and where communicating with the second network entity via the time interval includes communicating one of the first transmission or the second transmission via the time interval in accordance with the conflict resolution scheme.

In some examples of the method, apparatuses, and non-transitory computer-readable medium described herein, communicating one of the first transmission or the second transmission via the time interval may include operations, features, means, or instructions for communicating, in accordance with the conflict resolution scheme, the second transmission based on the second transmission being associated with the first communication direction, the first transmission including a first semi-statically scheduled transmission, and the second transmission including a second semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, whichever transmission of the first transmission and the second transmission that may be associated with a higher priority level based on the first transmission including a first semi-statically scheduled transmission and the second transmission including a second semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the first transmission based on the second communication direction being associated with a higher priority than the first communication direction, the first transmission including a first semi-statically scheduled transmission, and the second transmission including a second semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the second transmission based on the first communication direction being associated with a higher priority than the second communication direction, the first transmission including a first semi-statically scheduled transmission, and the second transmission including a second semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, a dynamically scheduled transmission based on the first transmission including a semi-statically scheduled transmission and the second transmission including the dynamically scheduled transmission or the first transmission including the dynamically scheduled transmission and the second transmission including the semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the second transmission based on the second transmission being associated with the first communication direction and the first transmission including a semi-statically scheduled transmission and the second transmission including a dynamically scheduled transmission or the first transmission including a dynamically scheduled transmission and the second transmission including a semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, one of the first transmission or the second transmission based on a timing order in which the scheduling information and the second scheduling information was received, the first transmission including a first dynamically scheduled transmission, and the second transmission including a second dynamically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, one of the first transmission or the second transmission based on a first time domain resource allocation, a second time domain resource allocation, the first transmission including a first dynamically scheduled transmission, and the second transmission including a second dynamically scheduled transmission, where the scheduling information includes an indication of the first time domain resource allocation associated with the first transmission, and where the second scheduling information includes an indication of the second time domain resource allocation associated with the second transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, whichever transmission of the first transmission and the second transmission that may be associated with a higher priority level based on the first transmission including a first dynamically scheduled transmission and the second transmission including a second dynamically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the second transmission based on the first communication direction being associated with a higher priority than the second communication direction, the first transmission including a first dynamically scheduled transmission, and the second transmission including a second dynamically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the first transmission based on the second communication direction being associated with a higher priority than the first communication direction, the first transmission including a first dynamically scheduled transmission, and the second transmission including a second dynamically scheduled transmission.

Some examples of the method, apparatuses, and non-transitory computer-readable medium described herein may further include operations, features, means, or instructions for receiving the scheduling information includes receiving RRC signaling including the scheduling information.

A method for wireless communications at a first network entity is described. The method may include transmitting control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity, transmitting scheduling information for a first transmission between the first network entity and the second network entity in the time interval and the second set of frequency resources for the time interval, where the scheduling information includes an indication that the first transmission is associated with the second communication direction, and communicating with the second network entity via the time interval in accordance with a conflict resolution scheme based on the time interval being associated with the first communication direction and the first transmission being associated with the second communication direction.

A first network entity for wireless communications. The first network entity may include at least one communications interface, and at least one processor coupled to the at least one communications interface. The first network entity may be configured to transmit control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity, transmit scheduling information for a first transmission between the first network entity and the second network entity in the time interval and the second set of frequency resources for the time interval, where the scheduling information includes an indication that the first transmission is associated with the second communication direction, and communicate with the second network entity via the time interval in accordance with a conflict resolution scheme based on the time interval being associated with the first communication direction and the first transmission being associated with the second communication direction.

Another apparatus for wireless communications at a first network entity is described. The apparatus may include means for transmitting control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity, means for transmitting scheduling information for a first transmission between the first network entity and the second network entity in the time interval and the second set of frequency resources for the time interval, where the scheduling information includes an indication that the first transmission is associated with the second communication direction, and means for communicating with the second network entity via the time interval in accordance with a conflict resolution scheme based on the time interval being associated with the first communication direction and the first transmission being associated with the second communication direction.

A non-transitory computer-readable medium having code for wireless communications stored thereon is described. The code, when executed by a first network entity, causes the first network entity to transmit control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity, transmit scheduling information for a first transmission between the first network entity and the second network entity in the time interval and the second set of frequency resources for the time interval, where the scheduling information includes an indication that the first transmission is associated with the second communication direction, and communicate with the second network entity via the time interval in accordance with a conflict resolution scheme based on the time interval being associated with the first communication direction and the first transmission being associated with the second communication direction.

In some examples of the method, apparatuses, and non-transitory computer-readable medium described herein, communicating with the second network entity via the time interval may include operations, features, means, or instructions for communicating, in accordance with the conflict resolution scheme, the first transmission via the time interval and the second set of frequency resources.

In some examples of the method, apparatuses, and non-transitory computer-readable medium described herein, the time interval includes a flexible time interval type based on the first transmission being associated with the second communication direction in accordance with the conflict resolution scheme and communicating the first transmission via the time interval and the second set of frequency resources may be based on the time interval including the flexible time interval type.

Some examples of the method, apparatuses, and non-transitory computer-readable medium described herein may further include operations, features, means, or instructions for communicating, in accordance with the conflict resolution scheme, the first transmission via the time interval and the second set of frequency resources based on a DCI including the scheduling information, where transmitting the scheduling information includes transmitting the DCI including the scheduling information.

Some examples of the method, apparatuses, and non-transitory computer-readable medium described herein may further include operations, features, means, or instructions for transmitting second scheduling information for a second transmission between the first network entity and the second network entity in the time interval and the first set of frequency resources for the time interval, where the second scheduling information includes an indication that the second transmission may be associated with the first communication direction, and where communicating with the second network entity via the time interval includes communicating one of the first transmission or the second transmission via the time interval in accordance with the conflict resolution scheme.

In some examples of the method, apparatuses, and non-transitory computer-readable medium described herein, communicating one of the first transmission or the second transmission via the time interval may include operations, features, means, or instructions for communicating, in accordance with the conflict resolution scheme, the second transmission based on the second transmission being associated with the first communication direction, the first transmission including a first semi-statically scheduled transmission, and the second transmission including a second semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, whichever transmission of the first transmission and the second transmission that may be associated with a higher priority level based on the first transmission including a first semi-statically scheduled transmission and the second transmission including a second semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the first transmission based on the second communication direction being associated with a higher priority than the first communication direction, the first transmission including a first semi-statically scheduled transmission, and the second transmission including a second semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the second transmission based on the first communication direction being associated with a higher priority than the second communication direction, the first transmission including a first semi-statically scheduled transmission, and the second transmission including a second semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, a dynamically scheduled transmission based on the first transmission including a semi-statically scheduled transmission and the second transmission including the dynamically scheduled transmission or the first transmission including the dynamically scheduled transmission and the second transmission including the semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the second transmission based on the second transmission being associated with the first communication direction and the first transmission including a semi-statically scheduled transmission and the second transmission including a dynamically scheduled transmission or the first transmission including a dynamically scheduled transmission and the second transmission including a semi-statically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, one of the first transmission or the second transmission based on a timing order in which the scheduling information and the second scheduling information was transmitted, the first transmission including a first dynamically scheduled transmission, and the second transmission including a second dynamically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, one of the first transmission or the second transmission based on a first time domain resource allocation, a second time domain resource allocation, the first transmission including a first dynamically scheduled transmission, and the second transmission including a second dynamically scheduled transmission, where the scheduling information includes an indication of the first time domain resource allocation associated with the first transmission, and where the second scheduling information includes an indication of the second time domain resource allocation associated with the second transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, whichever transmission of the first transmission and the second transmission that may be associated with a higher priority level based on the first transmission including a first dynamically scheduled transmission and the second transmission including a second dynamically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the second transmission based on the first communication direction being associated with a higher priority than the second communication direction, the first transmission including a first dynamically scheduled transmission, and the second transmission including a second dynamically scheduled transmission.

In some examples of the method, apparatuses, and non-transitory computer-readable medium described herein, communicating one of the first transmission or the second transmission via the time interval may include operations, features, means, or instructions for communicating, in accordance with the conflict resolution scheme, the first transmission based on the second communication direction being associated with a higher priority than the first communication direction, the first transmission including a first dynamically scheduled transmission, and the second transmission including a second dynamically scheduled transmission.

Some examples of the method, apparatuses, and non-transitory computer-readable medium described herein may further include operations, features, means, or instructions for transmitting the scheduling information includes transmitting RRC signaling including the scheduling information.

### BRIEF DESCRIPTION OF THE DRAWINGS

FIG. 1 illustrates an example of a wireless communications system that supports collision handling for subband full duplex (SBFD) aware user equipments (UE)s in accordance with one or more aspects of the present disclosure.

FIG. 2 illustrates an example of a wireless communications system that supports collision handling for SBFD aware UEs in accordance with one or more aspects of the present disclosure.

FIG. 3 illustrates an example of a resource diagram that supports collision handling for SBFD aware UEs in accordance with one or more aspects of the present disclosure.

FIG. 4 illustrates an example of a resource diagram that supports collision handling for SBFD aware UEs in accordance with one or more aspects of the present disclosure.

FIG. 5 illustrates an example of a resource diagram that supports collision handling for SBFD aware UEs in accordance with one or more aspects of the present disclosure.

FIG. 6 illustrates an example of a resource diagram that supports collision handling for SBFD aware UEs in accordance with one or more aspects of the present disclosure.

FIG. 7 illustrates an example of a resource diagram that supports collision handling for SBFD aware UEs in accordance with one or more aspects of the present disclosure.

FIG. 8 illustrates an example of a process flow that supports collision handling for SBFD aware UEs in accordance with one or more aspects of the present disclosure.

FIGS. 9 and 10 show block diagrams of devices that support collision handling for SBFD aware UEs in accordance with one or more aspects of the present disclosure.

FIG. 11 shows a block diagram of a communications manager that supports collision handling for SBFD aware UEs in accordance with one or more aspects of the present disclosure.

FIG. 12 shows a diagram of a system including a device that supports collision handling for SBFD aware UEs in accordance with one or more aspects of the present disclosure.

FIGS. 13 and 14 show block diagrams of devices that support collision handling for SBFD aware UEs in accordance with one or more aspects of the present disclosure.

FIG. 15 shows a block diagram of a communications manager that supports collision handling for SBFD aware UEs in accordance with one or more aspects of the present disclosure.

FIG. 16 shows a diagram of a system including a device that supports collision handling for SBFD aware UEs in accordance with one or more aspects of the present disclosure.

FIGS. 17 through 20 show flowcharts illustrating methods that support collision handling for SBFD aware UEs in accordance with one or more aspects of the present disclosure.

### DETAILED DESCRIPTION

A network entity may implement a subband full duplex (SBFD) communication scheme, where a first set of frequency resources (which may include one or more non-contiguous subbands) may be used for communications in one direction (e.g., one of uplink or downlink), and a second set of frequency resources (which may include one or more non-contiguous subbands) may be used for communications in the other direction in a same time interval (e.g., the same slot or symbol). Some half duplex user equipments (UE)s may be aware that the network may operate in SBFD. A half duplex UE may transmit uplink communications or may receive downlink communications in a given time resource, but a half duplex UE is not capable of transmitting and receiving simultaneously in the same time resource. Each slot for a half duplex UE may be indicated or configured (e.g., via radio resource control (RRC) signaling) as either a downlink slot, an uplink slot, or a flexible slot. An SBFD aware half duplex UE may be scheduled (e.g., either dynamically via downlink control information (DCI) or via higher layer semi-static scheduling (such as RRC)) with a transmission in a conflicting (e.g., opposite) direction with respect to the configured slot direction for the half duplex UE. For example, an SBFD aware half duplex UE may be scheduled for an uplink transmission in a slot configured as a downlink slot for the half duplex UE (using the uplink subband(s) for that slot) or a downlink transmission in a slot configured as an uplink slot for the half duplex UE (using the downlink subband(s) for that slot). Currently, there are no conflict handling rules specifying whether an SBFD aware half duplex UE may transmit or receive a transmission in a slot that is in a conflicting direction to the configured slot direction for the half duplex UE.

A half duplex UE may determine whether to communicate a scheduled transmission in a conflicting direction of the configured time interval (e.g., slot) direction for the half duplex UE (where the slot is an SBFD slot for the network entity) in accordance with a conflict resolution scheme. In some cases, the UE may interpret a slot as a flexible slot if the UE is scheduled for a scheduled transmission in the opposite direction of the configured slot direction for the UE, and accordingly the UE may communicate the transmission. For example, the UE may transmit an uplink transmission in the uplink resources of an SBFD slot that was indicated to the UE as a downlink slot for the UE, or the UE may receive a downlink transmission in the downlink resources of an SBFD slot that was indicated to the UE as an uplink slot for the UE. In some cases, the UE may consider a scheduled communication in a conflicting direction as the slot direction for the UE as an error case, and the UE may accordingly drop or cancel the transmission. In some cases, the UE may be configured to communicate scheduled transmission in the opposite direction of the configured slot direction for the UE.

In some aspects, a half duplex UE may receive scheduling information for a second transmission in a slot that is scheduled for the same direction as the slot in addition to the transmission in the slot scheduled for a opposite direction as the slot. The UE may apply the conflict resolution scheme to determine whether to communicate the transmission in the opposite direction of the slot or the second transmission in the same direction as the slot. For example, the conflict resolution scheme may indicate to prioritize a transmission that is dynamically scheduled, that is in the same direction as the slot, that is in a given direction (e.g., either uplink or downlink may be prioritized), or that is indicated as having a higher priority level (e.g., based on communication type or retransmission number).

Aspects of the disclosure are initially described in the context of wireless communications systems. Aspects of the disclosure are further illustrated by and described with reference to resource diagrams and process flows. Aspects of the disclosure are further illustrated by and described with reference to apparatus diagrams, system diagrams, and flowcharts that relate to collision handling for SBFD aware UEs.

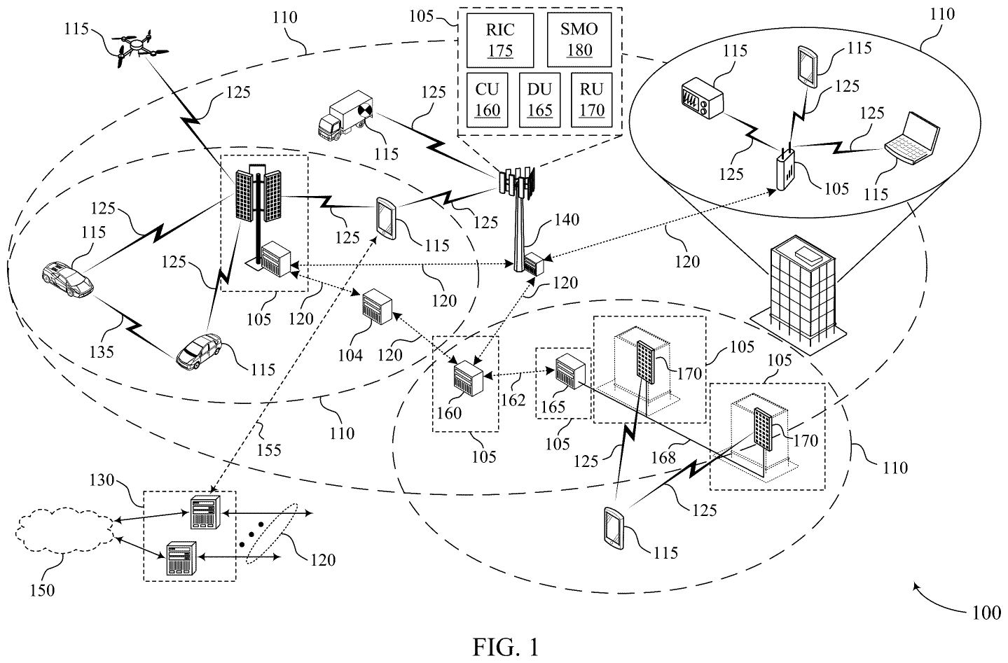

FIG. 1 illustrates an example of a wireless communications system 100 that supports collision handling for SBFD aware UEs in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an IAB network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support collision handling for SBFD aware UEs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (0f) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some aspects, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, a network entity 105 may implement an SBFD communication scheme, where a first set of frequency resources (which may include one or more non-contiguous subbands) may be used for communications in one direction (e.g., one of uplink or downlink), and a second set of frequency resources (which may include one or more non-contiguous subbands) may be used for communications in the other direction in a same time interval (e.g., the same slot or symbol). In some aspects, SBFD operation at a network entity may be transparent to a UE 115 (e.g., the time and frequency locations of subbands for SBFD operation may not be known to a UE 115). In some aspects, SBFD may be non-transparent to a UE 115. For example, some half duplex UEs 115 may be aware that the network entity 105 may operate in SBFD. In some aspects, only the time locations of subbands for SBFD operation may be known to a UE 115. In some aspects, both the time and frequency locations of subbands for SBFD operation may be known to a UE 115. In some aspects, an SBFD time resource (e.g., an SBFD symbol or slot) may be a downlink time resource with one or more configured uplink subbands. In some aspects, an SBFD time resource (e.g., an SBFD symbol or slot) may be a flexible time resource with one or more configured uplink subbands or one or more configured downlink subbands.

A half duplex UE 115 may transmit uplink communications or may receive downlink communications in a given time resource, but is not capable of transmitting and receiving simultaneously in the same time resource. Each slot for a half duplex UE 115 may be indicated or configured (e.g., via RRC signaling) as either a downlink slot, an uplink slot, or a flexible slot. An SBFD aware half duplex UE 115 may be scheduled (e.g., either dynamically via DCI or via higher layer semi-static scheduling (such as RRC)) with a transmission in a conflicting (e.g., opposite) direction with respect to the configured slot direction for the half duplex UE 115. For example, an SBFD aware half duplex UE 115 may be scheduled for an uplink transmission in a slot configured as a downlink slot for the half duplex UE 115 (using the uplink subband(s) for that slot) or a downlink transmission in a slot configured as an uplink slot for the half duplex UE 115 (using the downlink subband(s) for that slot).

A half duplex UE 115 may determine whether to communicate a scheduled transmission in a conflicting direction of the configured time interval (e.g., slot) direction for the half duplex UE 115 (where the slot is an SBFD slot for the network entity 105) in accordance with a conflict resolution scheme. In some cases, the UE 115 may interpret a slot as a flexible slot if the UE 115 is scheduled for a scheduled transmission in the opposite direction of the configured slot direction for the UE 115, and accordingly the UE 115 may communicate the transmission. For example, the UE 115 may transmit an uplink transmission in the uplink resources of an SBFD slot that was indicated to the UE 115 as a downlink slot for the UE 115, or the UE 115 may receive a downlink transmission in the downlink resources of an SBFD slot that was indicated to the UE 115 as an uplink slot for the UE 115. In some cases, the UE 115 may consider a scheduled communication in a conflicting direction as the slot direction for the UE 115 as an error case, and the UE 115 may accordingly drop or cancel the transmission. In some cases, the UE 115 may be configured to communicate scheduled transmission in the opposite direction of the configured slot direction for the UE 115. In some aspects, the network entity 105 may apply the same conflict resolution scheme as the UE 115 for the transmission between the UE 115 and the network entity scheduled for the opposite direction as the configured slot direction for the UE 115.

In some aspects, a half duplex UE 115 may receive scheduling information for a second transmission in a slot that is scheduled for the same direction as the slot in addition to the transmission in the slot scheduled for a opposite direction as the slot. The UE 115 may apply the conflict resolution scheme to determine whether to communicate the transmission in the opposite direction of the configured slot direction for the UE 115 or the second transmission in the same direction as configured slot direction for the UE 115. For example, the conflict resolution scheme may indicate to prioritize a transmission that is dynamically scheduled, that is in the same direction as the slot, that is in a given direction (e.g., either uplink or downlink may be prioritized), or that is indicated as having a higher priority level (e.g., based on communication type or retransmission number). In some aspects, the network entity 105 may apply the same conflict resolution scheme as the UE 115 to determine whether to communicate the transmission in the opposite direction of the configured slot direction for the UE 115 or the second transmission in the same direction as configured slot direction for the UE 115.

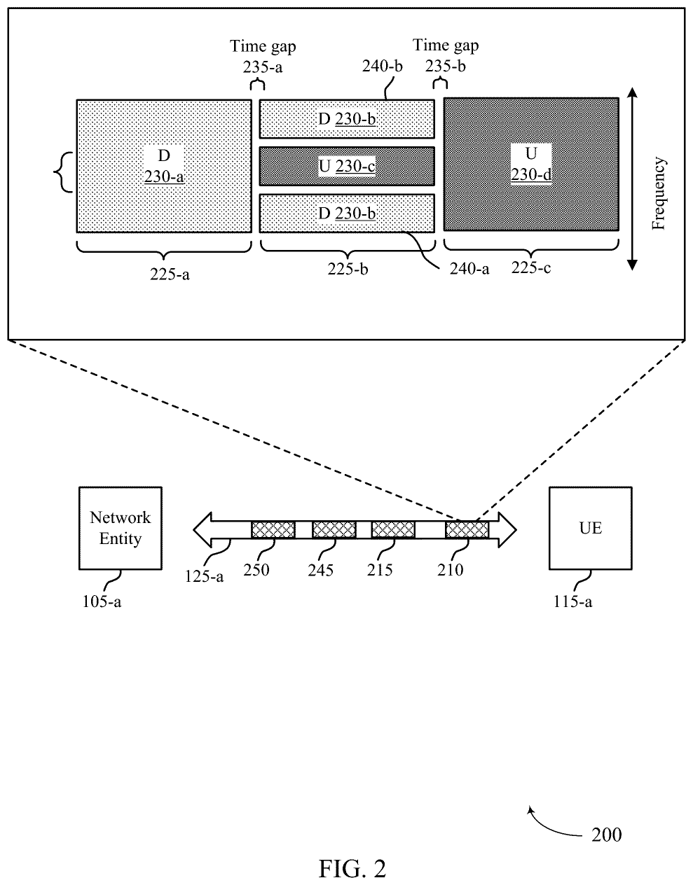

FIG. 2 illustrates an example of a wireless communications system 200 that supports collision handling for SBFD aware UEs in accordance with one or more aspects of the present disclosure. The wireless communications system 200 may include a UE 115-a, which may be an example of a UE 115 as described herein. The wireless communications system 200 may include a network entity 105-a, which may be an example of a network entity 105 as described herein.

The UE 115-a may communicate with the network entity 105-a using a communication link 125-a, which may be an example of an NR or LTE link between the UE 115-a and the network entity 105-a. The communication link 125-a may include a bi-directional link that enables both uplink and downlink communication. For example, the UE 115-a may transmit uplink transmissions, such as uplink control signals or uplink data signals, to the network entity 105-a using the communication link 125-a and the network entity 105-a may transmit downlink transmissions, such as downlink control signals or downlink data signals, to the UE 115-a using the communication link 125-a.

The network entity 105-a and the UE 115-a may implement SBFD communications. Some half duplex UEs 115 may be aware that the network may operate in SBFD, such that the UE 115 may be SBFD-aware. Some UEs 115 may operate in a half duplex configuration, in which the UE 115 may transmit uplink communications (U) or may receive downlink communications (D) in a given time resource, but may not transmit and receive simultaneously in the same time resource (e.g., such as in a slot). Each slot for a half duplex UE 115 may be a downlink slot (D), an uplink slot (U), or a flexible slot (F). The network entity 105-a may indicate to the UE 115-a that some of slots (D, U or F) are used for network entity SBFD operation and indicate to the UE 115-a the locations of the uplink and downlink subbands in the SBFD symbols. An SBFD aware half duplex UE 115 may be scheduled (e.g., either dynamically via DCI or via higher layer semi-static scheduling) with a transmission in the conflicting direction of the configured direction of the slot for the UE 115 (e.g., slot direction). For example, an SBFD aware half duplex UE 115-a may be scheduled for an uplink transmission in a downlink slot (using the uplink subband(s) for that slot that the network entity 105-a uses for SBFD operation) or a downlink transmission in an uplink slot (using the downlink subband(s) for that slot that the network entity 105-a uses for SBFD operation). As discussed herein, collision handling rules (e.g., a conflict resolution scheme) may specify whether an SBFD aware half duplex UE 115 may transmit or receive a transmission in a slot that is in a conflicting direction to the configured slot direction for the UE.

The UE 115-a may be an SBFD aware half duplex UE 115. The UE 115-a may receive, from the network entity 105-a, control signaling 210 including an indication of a BWP, such as a BWP 230-a associated with a first communication direction (e.g., downlink), a BWP 230-b also associated with the first communication direction, a BWP 230-c associated with a second communication direction (e.g., uplink), and a BWP 230-d also associated with the second communication direction. The control signaling may indicate which slot is associated with which BWP. For example, a slot 225-a may be associated with the BWP 230-a (e.g., a downlink slot), a slot 225-b may be associated with the BWP 230-c and the BWP 230-b (e.g., an SBFD slot), and the slot 225-c may be associated with the BWP 230-d (e.g., an uplink slot). In some aspects, the SBFD slot 225-b may be a downlink slot with one or more configured uplink subbands (e.g., the uplink BWP 230-c). In some aspects, the SBFD slot 225-b may be a flexible slot with one or more configured uplink subbands (e.g., the uplink BWP 230-c).

An SBFD slot (e.g., the slot 225-b) may include subbands 240. For example, the BWP 230-b includes a first subband 240-a and a second subband 240-b, which may be non-contiguous in the frequency domain. Each of the BWP 230 (e.g., a band or a subband) may be associated with a set of respective resources, such as resource blocks (RB)s. The BWP 230-b that includes the first subband 240-a may be associated with a first set of RBs and the second subband 240-b may be associated with a second set of RBs, and they may not be contiguous in a frequency domain. The BWP 230-c and its respective RBs may not overlap with the first subband 240-a and the second subband 240-b. In some examples, a guard band may include RBs between the RBs associated with the BWP 230-b and the BWP 230-c.

The control signaling 210 may indicate that an SBFD mode including the BWP 230-b and the BWP 230-c applies to a set of time resources for a slot 225-b.

The network entity 105-a and the UE 115-a may exchange communications 215 during the slot 225-b, where the network entity 105-a operates in an SBFD mode via the BWP 230-b and the BWP 230-c. If the UE 115-a is a half duplex UE, the UE 115-a may be configured to either transmit uplink signals in the BWP 230-c or to receive signals in the BWP 230-b in the slot 225-b. The network entity 105-a may transmit signals to one or more UEs 115 in the BWP 230-b and receive uplink signals in the BWP 230-c in the slot 225-b (e.g., in an SBFD mode).

In some examples, the control signaling 210 may be RRC signaling. In some examples, the control signaling 210 may include a BWP information element (IE) that indicates the RBs associated with the downlink BWP (e.g., the BWP 230-b) and the uplink BWP (e.g., the BWP 230-c). For example, the control signaling 210 may include an IE for each of the BWP 230-a and the BWP 230-b that indicates an array that indicates the RBs included in the respective BWP 230. The control signaling 210 may indicate the communication direction (e.g., uplink or downlink) for each BWP 230 (e.g., the BWP 230-b and the BWP 230-c). In some examples, the control signaling 210 may indicate for each slot whether the slot is configured as an uplink slot, a downlink slot, or a flexible slot for the UE 115-a. In a flexible slot, the UE 115-a may determine to either transmit uplink signals or receive downlink signals. In some examples, the control signaling 210 may indicate only the time locations that are SBFD (e.g., the slots/symbols where the network entity 105-a performs SBFD communications). In some examples, the control signaling 210 may indicate both the time and frequency locations (e.g., the RBs for uplink and downlink for an SBFD slot/symbol).

In a half-duplex configuration, the network entity 105-a may transmit downlink signals in a downlink slot via the BWP 230-a and may receive uplink signals in a slot the BWP 230-d. In half-duplex operations, slots may switch or rotate according to a pattern between uplink and downlink slots. In a half-duplex configuration, the UE 115-a and the network entity 105-a may switch between the BWP 230-a and the BWP 230-d. For a half-duplex configuration, a BWP pair (e.g., the BWP 230-a and the BWP 230-d) have the same BWP ID and the same center frequency. For an SBFD configuration, a IE may include an array that indicates multiple values which may be used to determine the RBs in the BWPs. The network entity 105-a may configure, via the control signaling 210, one BWP 230 and/or subbands 240 to a direction of communication, either as downlink or uplink.

In some aspects, the UE 115-a may receive scheduling information 245 (e.g., via a DCI or RRC signaling) scheduling a transmission 250 that is opposite to the direction of communication for the UE 115-a for the slot 225-b. For example, the control signaling 210 may indicate that the slot 225-b is a downlink slot for the UE 115-a, and the scheduling information 245 may schedule an uplink transmission 250 for the UE 115-b via the BWP 230-c. As another example, the control signaling 210 may indicate that the slot 225-b is an uplink slot for the UE 115-a, and the scheduling information 245 may schedule a downlink transmission 250 for the UE 115-b via the BWP 230-c

The conflicting communication directions for the UE 115-a between the scheduled transmission 250 and the direction indicated for the slot 225-b by the control signaling 210 may result in a time domain collision. The UE 115-a and the network entity 105-a may implement a conflict resolution scheme to resolve such a time domain collision.

In some examples, the control signaling 210 may also indicate gap periods or delays, such as a time gap 235-a and a time gap 235-b between the sets of time resources of slots 225 corresponding to BWP 230 transmission switching (e.g., uplink and downlink transmission). The gap periods (the time gap 235-a and the time gap 235-b) may include a number of symbols or resources of slots 225 depending on, for example, filter tuning latency of the UE 115-a.

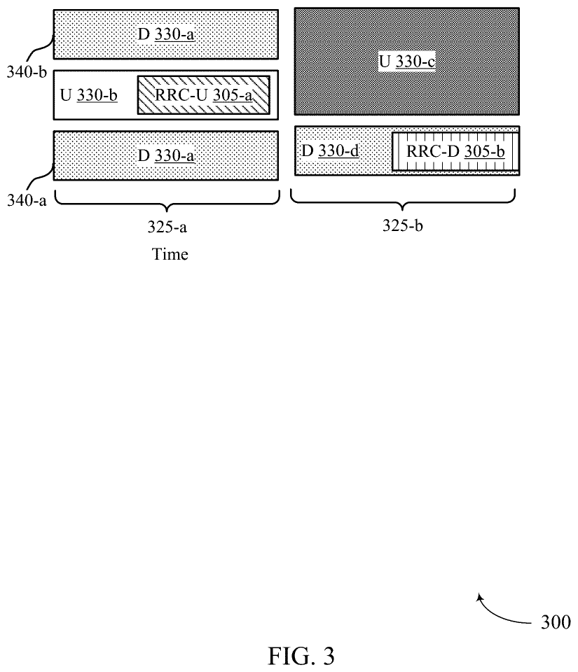

FIG. 3 illustrates an example of a resource diagram 300 that supports collision handling for SBFD aware UEs in accordance with one or more aspects of the present disclosure. The resource diagram 300 may implement aspects of the wireless communications system 100 or the wireless communications system 200.

A slot 325-a may include a BWP 330-a that is configured for downlink transmissions and a BWP 330-b that is configured for uplink transmission. A slot 325-b may include a BWP 330-c that is configured for uplink transmissions and a BWP 330-d that is configured for downlink transmission. The BWPs and subbands associated with the BWPs (e.g., a first subband 340-a and a second subband 340-b of the BWP 330-a) may operate and correspond to BWPs 230 and subbands 240 of FIG. 2.

The resource diagram 300 illustrates an example of a conflict between a semi-statically configured slot direction for a UE 115 and a semi-statically/RRC scheduled transmission (e.g., an uplink transmission 305-a in the BWP 330-b of the slot 325-a where the slot 325-a is configured as a downlink slot for the UE 115 or a downlink transmission 305-b in the BWP 330-d of the slot 325-b where the slot 325-b is configured as an uplink slot for the UE 115). For example, an SBFD aware UE 115 (e.g., aware of the time or time and frequency locations of an SBFD operation) may be configured by higher layers (e.g., RRC signaling) to transmit an uplink transmission 305-a, which may be a sounding reference signal (SRS), a physical uplink control channel (PUCCH) transmission, a physical uplink shared channel (PUSCH) transmission, or a physical random access channel (PRACH) transmission. Similarly, an SBFD aware UE 115 may be configured by higher layers (e.g., RRC signaling) to receive a downlink transmission 305-b, which may be a physical downlink control channel (PDCCH) transmission, a physical downlink shared channel (PDSCH) transmission, or a channel state information reference signal (CSI-RS). The slot 325-a may be indicated as a downlink slot by the broadcast parameter dd-UL-DL-ConfigurationCommon, or the slot 325-b may be indicated as an uplink slot by the UE dedicated RRC parameter tdd-UL-DLConfigurationDedicated. As used herein, a semi-static D/U/F may refer to symbols configured as downlink, uplink, or flexible, respectively, in tdd-UL-DL-ConfigurationCommon and/or tdd-UL-DL-ConfigurationDedicated.

As used herein, an RRC-D may refer to a semi-static PDCCH/PDSCH/CSI-RS transmission scheduled by a higher layer configuration. As used herein, RRC-U refer to semi-static PUCCH/PUSCH/SRS/PRACH transmission scheduled by a higher layer configuration. Dynamic D may refer to PDSCH/CSI that is dynamically scheduled by DCI. As used herein, dynamic U may include PUCCH/PUSCH/SRS that is dynamically scheduled by DCI.

The control signaling 210 may indicate the slot direction (uplink for the slot 325-a or downlink for the slot 325-b), and scheduling information 245 (e.g., RRC signaling) may schedule the uplink transmission 305-a or the downlink transmission 305-b.

As part of a conflict resolution scheme to the time domain collision, a UE 115 and the network entity 105 may determine whether to communicate a scheduled transmission (e.g., the uplink transmission 305-a or the downlink transmission 305-b) in the opposite direction of the slot direction for the UE 115.

In some aspects, in accordance with the conflict resolution scheme, the UE 115 and the network entity 105 may determine to communicate a transmission (e.g., the uplink transmission 305-a or the downlink transmission 305-b) in the opposite direction of the slot direction for the UE 115.

In some cases, the UE 115 may interpret a slot (e.g., the slot 325-a or the slot 325-b) as a flexible slot if the UE 115 is scheduled for a scheduled transmission in the opposite direction of the configured slot direction, and accordingly the UE and the network entity 105 may communicate the transmission. For example, the UE 115 may transmit an uplink transmission 305-a in the uplink resources of a slot 325-a that was indicated to the UE 115 as a downlink slot, or the UE 115 may receive a downlink transmission 305-b in the downlink resources of a slot 325-b that was indicated to the UE 115 as an uplink slot.

In some cases, the UE 115 may consider the scheduled transmission (e.g., the uplink transmission 305-a or the downlink transmission 305-b) as an error case, and drop or cancel the transmission. That is, the UE 115 does not transmit a PUCCH, PUSCH or PRACH that is configured by higher layers, or the UE 115 does not receive a PDCCH, PDSCH or CSI-RS that is configured by higher layers on a set of symbols.

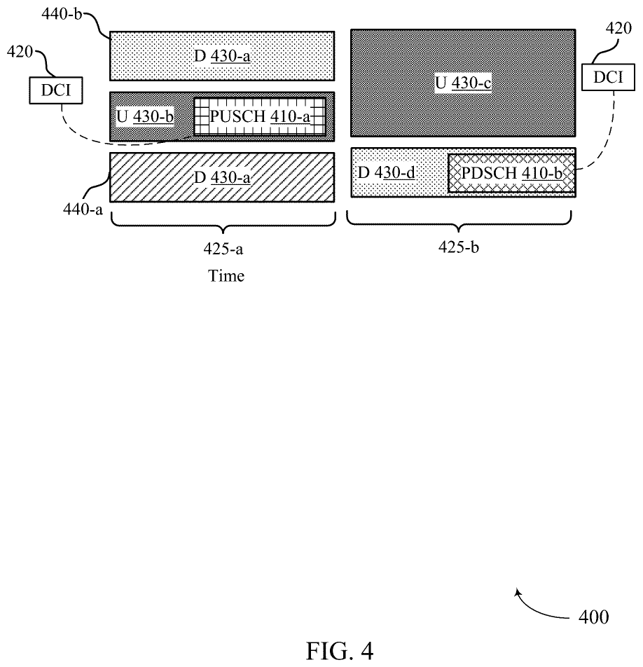

FIG. 4 illustrates an example of a resource diagram 400 that supports collision handling for SBFD aware UEs in accordance with one or more aspects of the present disclosure. The resource diagram 400 may implement aspects of the wireless communications system 100 or the wireless communications system 200.

A slot 425-a may include a BWP 430-a that is configured for downlink transmissions and a BWP 430-b that is configured for uplink transmission. A slot 425-b may include a BWP 430-c that is configured for uplink transmissions and a BWP 430-d that is configured for downlink transmission. The BWPs and subbands associated with the BWPs (e.g., a first subband 440-a and a second subband 440-b of the BWP 430-a) may operate and correspond to BWPs 230 and subbands 240 of FIG. 2.

The resource diagram 400 illustrates an example of a conflict between a semi-statically configured slot direction for a UE 115 and a dynamically scheduled transmission (e.g., an uplink transmission 410-a scheduled by a DCI 420 in the BWP 430-b of the slot 425-a where the slot 425-a is configured as a downlink slot for the UE 115, or a downlink transmission 410-b scheduled by a DCI 420 in the BWP 430-d of the slot 425-b where the slot 425-b is configured as an uplink slot for the UE 115).

In some examples, when the UE 115 detects a DCI 420 scheduling a transmission (e.g., an uplink transmission 410-a or a downlink transmission 410-b) on the SBFD symbol(s) in the opposite direction of the indicated direction by the broadcast parameter tdd-UL-DL-ConfigurationCommon and/or the RRC parameter tdd-UL-DL-ConfigurationDedicated (and where the control signaling indicates the symbol(s) as SBFD symbol(s)), the UE 115 communicates the dynamically scheduled transmission (e.g., the uplink transmission 410-a or the downlink transmission 410-b). In some cases, the UE 115 communicates the dynamically scheduled transmission (e.g., the uplink transmission 410-a or the downlink transmission 410-b) as long as the transmission meets the minimum PDCCH processing time (N2) and slot offset for the UE 115.

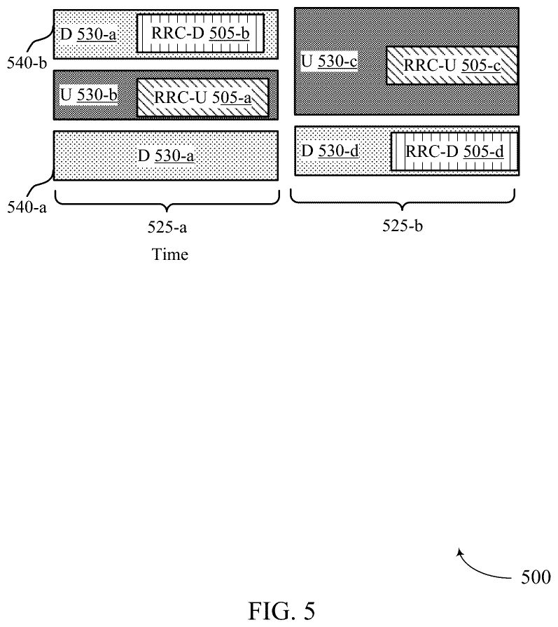

FIG. 5 illustrates an example of a resource diagram 500 that supports collision handling for SBFD aware UEs in accordance with one or more aspects of the present disclosure. The resource diagram 500 may implement aspects of the wireless communications system 100 or the wireless communications system 200.

A slot 525-a may include a BWP 530-a that is configured for downlink transmissions and a BWP 530-b that is configured for uplink transmission. A slot 525-b may include a BWP 530-c that is configured for uplink transmissions and a BWP 530-d that is configured for downlink transmission. The BWPs and subbands associated with the BWPs (e.g., a first subband 540-a and a second subband 540-b of the BWP 530-a) may operate and correspond to BWPs 230 and subbands 240 of FIG. 2.

As described herein, in some examples, a UE 115 may receive scheduling information scheduling two semi-statically scheduled transmissions in opposite directions in a slot (e.g., an RRC-D 505-b in the BWP 530-a of the slot 525-a and an RRC-U 505-a in the BWP 530-b of the slot 525-a, or an RRC-D 505-d in the BWP 530-d of the slot 525-b and an RRC-U 505-c in the BWP 530-b of the slot 525-a). The slot 525-a may be configured as a downlink slot for the UE 115, and/or the slot 525-b may be configured as an uplink slot for the UE 115. For example, an SBFD aware UE 115 may be configured by higher layers to transmit an uplink transmission 505-a (e.g., an SRS, PUCCH, PUSCH or PRACH) and a downlink transmission 505-b (e.g., a PDCCH, PDSCH, or CSI-RS) in the slot 525-a and/or an uplink transmission 505-c (e.g., an SRS, PUCCH, PUSCH or PRACH) and a downlink transmission 505-d (e.g., a PDCCH, PDSCH, or CSI-RS) in the slot 525-b where the slot is used for SBFD operation at the network entity.

In some aspects, in accordance with the conflict resolution scheme, the UE 115 may determine to receive, and the network entity 105 may be configured to transmit, the RRC-D 505-b if the slot 525-a is indicated to the UE 115 as a downlink slot by the broadcast parameter tdd-UL-DL-ConfigurationCommon or the UE dedicated RRC parameter tdd-UL-DLConfigurationDedicated. In some aspects, in accordance with the conflict resolution scheme, the UE 115 may determine to receive, and the network entity 105 may be configured to transmit, the RRC-U 505-c if the slot 525-b is indicated to the UE 115 as an uplink slot by the broadcast IE parameter tdd-UL-DL-ConfigurationCommon or the UE dedicated RRC parameter tdd-UL-DLConfigurationDedicated.

In some aspects, in accordance with the conflict resolution scheme, the UE 115 may determine which transmission (e.g., the RRC-U 505-a or the RRC-D 505-b in the slot 525-a, or the RRC-U 505-c or the RRC-D 505-d in the slot 525-b) based on a priority rule determined based on the configured uplink transmission type or the configured downlink transmission type (e.g., data PDSCH/PUSCH versus PDCCH/PUCCH, the content of the transmission, the physical/logical priority, the time domain behavior, length, or repetition number).

In some aspects, in accordance with the conflict resolution scheme, the UE 115 and the network entity 105 may always prioritize one communication direction (e.g., uplink is always prioritized or downlink is always prioritized).

In some aspects, the UE 115 may consider two semi-statically scheduled transmissions in opposite directions in a slot to be an error case, and may drop or cancel both transmissions.

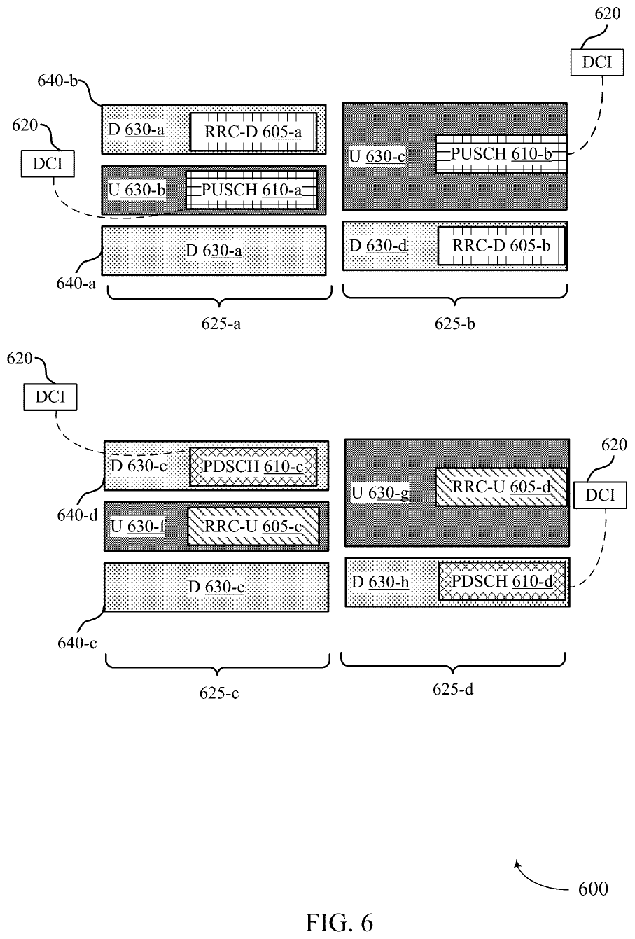

FIG. 6 illustrates an example of a resource diagram 600 that supports collision handling for SBFD aware UEs in accordance with one or more aspects of the present disclosure. The resource diagram 600 may implement aspects of the wireless communications system 100 or the wireless communications system 200.

A slot 625-a may include a BWP 630-a that is configured for downlink transmissions and a BWP 630-b that is configured for uplink transmission. A slot 625-b may include a BWP 630-c that is configured for uplink transmissions and a BWP 630-d that is configured for downlink transmissions. A slot 625-c may include a BWP 630-e that is configured for downlink transmissions and a BWP 630-f that is configured for uplink transmission. A slot 625-d may include a BWP 630-g that is configured for uplink transmissions and a BWP 630-h that is configured for downlink transmissions.

The BWPs and subbands associated with the BWPs (e.g., a first subband 640-a and a second subband 640-b of the BWP 630-a, and a first subband 640-c and a second subband 640-d of the BWP 630-a) may operate and correspond to BWPs 230 and subbands 240 of FIG. 2.

The resource diagram 600 illustrates conflicts between semi-statically scheduled transmissions by higher layer configuration (e.g., an RRC-U or an RRC-D) and a dynamically scheduled transmission (e.g., a PUSCH or PDSCH scheduled by a DCI 620).

An SBFD aware UE 115 may be configured by higher layers to receive an RRC-D (e.g., an RRC-D 605-a or an RRC-D 605-b) and may detect a DCI 620 scheduling an uplink transmission (e.g., a PUSCH 610-a or a PUSCH 610-b) in an SBFD symbol(s)/slot (e.g., the slot 625-a or the slot 625-b). The slot 625-a or the slot 625-b may be indicated as downlink or uplink by the broadcast parameter tdd-UL-DL-ConfigurationCommon or the UE dedicated RRC parameter tdd-UL-DLConfigurationDedicated. For example, the slot 625-a may be configured to the UE 115 as a downlink slot and the slot 625-b may be configured as an uplink slot while the slot is used for SBFD operation at the network entity 105.

In some examples, in accordance with the conflict resolution scheme, the UE 115 and the network entity 105 may prioritize the transmission scheduled by the DCI 620 (e.g., the dynamically scheduled PUSCH 610-a in the slot 625-a and the dynamically scheduled PUSCH 610-b in the slot 625-b), and the UE 115 and the network entity 105 may drop or cancel the RRC-D. In some examples, the UE 115 and the network entity 105 may communicate the transmission that is in the same direction as the configured direction for the slot (e.g., the RRC-D 605-a in the slot 625-a and the PUSCH 610-b in the slot 625-b) and may drop or cancel the other transmission (e.g., the PUSCH 610-a in the slot 625-a and the RRC-D 605-b in the slot 625-b).

An SBFD aware UE 115 may be configured by higher layers to receive an RRC-U (e.g., an RRC-U 605-c or an RRC-U 605-d) and may detect a DCI 620 scheduling a downlink transmission (e.g., a PDSCH 610-c or a PDSCH 610-d) in an SBFD symbol(s)/slot (e.g., the slot 625-c or the slot 625-d). The slot 625-c or the slot 625-c may be indicated as downlink or uplink by the broadcast parameter tdd-UL-DL-ConfigurationCommon or the UE dedicated RRC parameter tdd-UL-DLConfigurationDedicated. For example, the slot 625-c may be configured to the UE 115 as a downlink slot and the slot 625-d may be configured as an uplink slot while the slot is used for SBFD operation at the network entity 105.

In some examples, in accordance with the conflict resolution scheme, the UE 115 and the network entity 105 may prioritize the transmission scheduled by the DCI 620 (e.g., the dynamically scheduled PDSCH 610-c in the slot 625-c and the dynamically scheduled PDSCH 610-d in the slot 625-d), and the UE 115 and the network entity 105 may drop or cancel the RRC-U. In some examples, the UE 115 and the network entity 105 may communicate the transmission that is in the same direction as the configured direction for the slot (e.g., the RRC-U 605-d in the slot 625-d and the PDSCH 610-c in the slot 625-c) and may drop or cancel the other transmission (e.g., the PDSCH 610-d in the slot 625-d and the RRC-U 605-c in the slot 625-c).

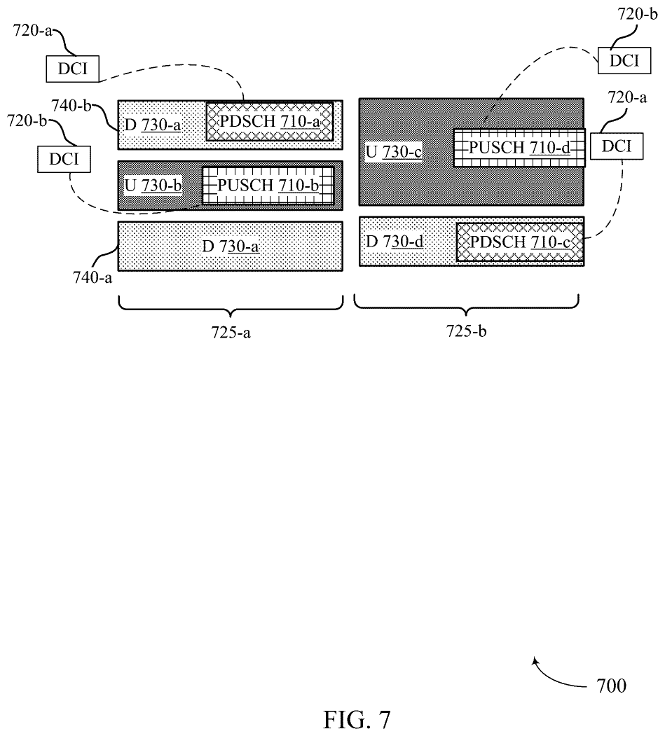

FIG. 7 illustrates an example of a resource diagram 700 that supports collision handling for SBFD aware UEs in accordance with one or more aspects of the present disclosure. The resource diagram 700 may implement aspects of the wireless communications system 100 or the wireless communications system 200.

A slot 725-a may include a BWP 730-a that is configured for downlink transmissions and a BWP 730-b that is configured for uplink transmission. A slot 725-b may include a BWP 730-c that is configured for uplink transmissions and a BWP 730-d that is configured for downlink transmission. The BWPs and subbands associated with the BWPs (e.g., a first subband 740-a and a second subband 740-b of the BWP 730-a) may operate and correspond to BWPs 230 and subbands 240 of FIG. 2.

The resource diagram 700 illustrates conflicts between two dynamically scheduled transmissions (e.g., a PDSCH scheduled by a DCI 720-a and a PUSCH scheduled by a DCI 720-b).

An SBFD aware UE 115 may detect two DCIs (DCI 720-a and DCI 720-b) scheduling transmissions in opposite directions in the same slot (e.g., the slot 725-a and the slot 725-b). For example, the DCI 720-a may schedule a PDSCH 710-a and the DCI 720-b may schedule a PUSCH 710-b in the slot 725-a, and the DCI 720-a may schedule a PDSCH 710-c and the DCI 720-b may schedule a PUSCH 710-d in the slot 725-b. The slot 725-a or the slot 725-b may be indicated as downlink or uplink by the broadcast parameter tdd-UL-DL-ConfigurationCommon or the UE dedicated RRC parameter tdd-UL-DLConfigurationDedicated. For example, the slot 725-a may be configured to the UE 115 as a downlink slot and the slot 725-b may be configured as an uplink slot while the UE 115 is aware that slot is used for SBFD operation at the network entity 105.

In some aspects, the UE 115 and the network entity 105 may consider such a collision an error case, and may cancel or drop both dynamically scheduled transmissions (e.g., may drop or cancel the PDSCH 710-a and the PUSCH 710-b in the slot 725-a, or may drop or cancel the PDSCH 710-c and the PUSCH 710-d in the slot 725-b).

In some aspects, in accordance with the conflict resolution scheme, the UE 115 and the network entity 105 may prioritize the transmission that is scheduled in the same direction as the configured slot direction for the UE, and may drop or cancel the other transmission. For example, in the slot 725-a, the UE 115 and the network entity 105 may communicate the PDSCH 710-a and drop or cancel the PUSCH 710-b. Similarly, in the slot 725-b, the UE 115 and the network entity 105 may communicate the PUSCH 710-d and drop or cancel the PDSCH 710-c.

In some aspects, in accordance with the conflict resolution scheme, the UE 115 and the network entity 105 may prioritize the transmissions based on a timing order in which the scheduling DCIs (the DCI 720-a and the DCI 720-b) were transmitted/received. For example, the UE 115 and the network entity may communicate the earlier scheduled transmission and drop the later scheduled transmission, or vice versa.

In some aspects, in accordance with the conflict resolution scheme, the UE 115 and the network entity 105 may prioritize the transmissions based on respective time domain resource allocation (TDRA) configurations of the PUSCH and PDSCH. The respective TDRAs may be indicated in the respective scheduling DCIs (the DCI 720-a and the DCI 720-b). For example, the UE 115 and the network entity 105 may communicate the transmission with repetition, the transmission that starts earlier, the transmission that lasts longer, or based on k0/2 values, and may drop or cancel the other transmission.

In some aspects, in accordance with the conflict resolution scheme, the UE 115 and the network entity 105 may prioritize one communication direction (e.g., either uplink or downlink), and may drop or cancel the transmission in the opposite direction. In some aspects, the scheduling DCI may include a bitfield for the priority of the scheduled communication.

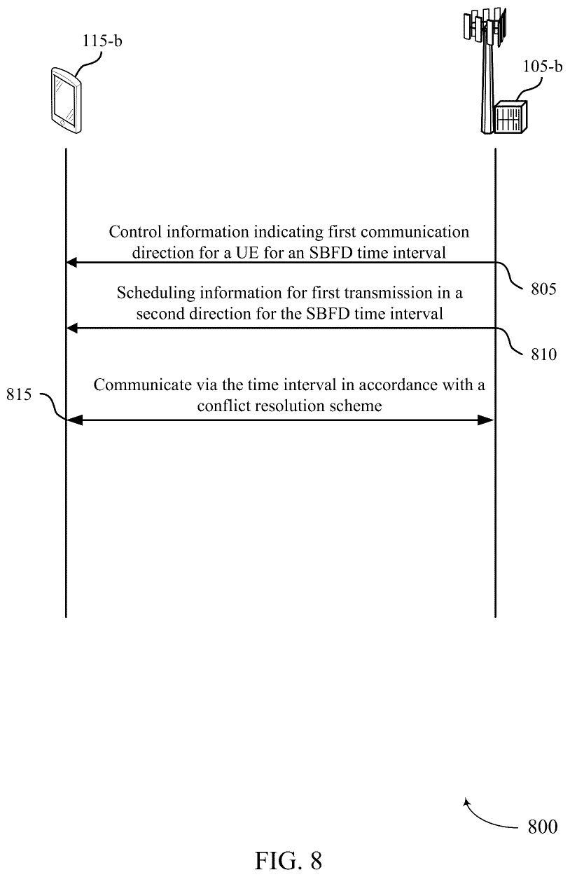

FIG. 8 illustrates an example of a process flow 800 that supports collision handling for SBFD aware UEs in accordance with one or more aspects of the present disclosure. The process flow 800 may include a UE 115-b, which may be an example of a UE 115 as described herein. The process flow 800 may include a network entity 105-b, which may be an example of a network entity 105 as described herein. In the following description of the process flow 800, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 800, and other operations may be added to the process flow 800.

At 805, the network entity 105-b may transmit, and the UE 115-b may receive, control information including an indication that a time interval is associated with SBFD communications for the network entity 105-b, where the control information further includes an indication of a first set of frequency resources for the time interval associated with a first communication direction and a second set of frequency resources for the time interval associated with a second communication direction, and where the control information includes an indication that the time interval is associated with the first communication direction for the UE 115-b.

At 810, the network entity 105-b may transmit, and the UE 115-b may receive, scheduling information for a first transmission between the UE 115-b and the network entity 105-b in the time interval and the second set of frequency resources for the time interval, where the scheduling information includes an indication that the first transmission is associated with the second communication direction.

At 815, the network entity 105-b and the UE 115-b may communicate via the time interval in accordance with a conflict resolution scheme based on the time interval being associated with the first communication direction for the UE 115-b and the first transmission being associated with the second communication direction.

In some aspects, communicating via the time interval includes communicating, in accordance with the conflict resolution scheme, the first transmission via the time interval and the second set of frequency resources. In some aspects, the time interval is a flexible time interval type based on the first transmission being associated with the second communication direction in accordance with the conflict resolution scheme, and communicating the first transmission via the time interval and the second set of frequency resources is based on the time interval being a flexible time interval type.

In some aspects, the network entity 105-b and the UE 115-b may communicate, in accordance with the conflict resolution scheme, the first transmission via the time interval and the second set of frequency resources based on a DCI including the scheduling information, where the UE 115-b receiving the scheduling information includes receiving the DCI including the scheduling information.

In some aspects, the network entity 105-b may transmit, and the UE 115-b may receive, second scheduling information for a second transmission between the UE 115-b and the network entity 105-b in the time interval and the first set of frequency resources for the time interval, where the second scheduling information includes an indication that the second transmission is associated with the first communication direction, and where communicating via the time interval includes communicating one of the first transmission or the second transmission via the time interval in accordance with the conflict resolution scheme.

In some aspects, communicating one of the first transmission or the second transmission via the time interval includes communicating, in accordance with the conflict resolution scheme, the second transmission based on the second transmission being associated with the first communication direction, the first transmission being a first semi-statically scheduled transmission, and the second transmission being a second semi-statically scheduled transmission.

In some aspects, communicating one of the first transmission or the second transmission via the time interval includes communicating, in accordance with the conflict resolution scheme, whichever transmission of the first transmission and the second transmission that is associated with a higher priority level based on the first transmission being a first semi-statically scheduled transmission and the second transmission being a second semi-statically scheduled transmission.

In some aspects, communicating one of the first transmission or the second transmission via the time interval includes communicating, in accordance with the conflict resolution scheme, the first transmission based on the second communication direction being associated with a higher priority than the first communication direction, the first transmission being a first semi-statically scheduled transmission, and the second transmission being a second semi-statically scheduled transmission.

In some aspects, communicating one of the first transmission or the second transmission via the time interval includes communicating, in accordance with the conflict resolution scheme, the second transmission based on the first communication direction being associated with a higher priority than the second communication direction, the first transmission being a first semi-statically scheduled transmission, and the second transmission being a second semi-statically scheduled transmission.

In some aspects, communicating one of the first transmission or the second transmission via the time interval includes communicating, in accordance with the conflict resolution scheme, a dynamically scheduled transmission based on the first transmission being a semi-statically scheduled transmission and the second transmission being the dynamically scheduled transmission or the first transmission being the dynamically scheduled transmission and the second transmission being the semi-statically scheduled transmission.

In some aspects, communicating one of the first transmission or the second transmission via the time interval includes communicating, in accordance with the conflict resolution scheme, the second transmission based on the second transmission being associated with the first communication direction and the first transmission being a semi-statically scheduled transmission and the second transmission being a dynamically scheduled transmission or the first transmission being a dynamically scheduled transmission and the second transmission being a semi-statically scheduled transmission.

In some aspects, communicating one of the first transmission or the second transmission via the time interval includes communicating, in accordance with the conflict resolution scheme, one of the first transmission or the second transmission based on a timing order in which the scheduling information and the second scheduling information was received, the first transmission being a first dynamically scheduled transmission, and the second transmission being a second dynamically scheduled transmission.

In some aspects, communicating one of the first transmission or the second transmission via the time interval includes communicating, in accordance with the conflict resolution scheme, one of the first transmission or the second transmission based on a first TDRA, a second TDRA, the first transmission being a first dynamically scheduled transmission, and the second transmission being a second dynamically scheduled transmission, where the scheduling information includes an indication of the first TDRA associated with the first transmission, and where the second scheduling information includes an indication of the second TDRA associated with the second transmission.

In some aspects, communicating one of the first transmission or the second transmission via the time interval includes communicating, in accordance with the conflict resolution scheme, whichever transmission of the first transmission and the second transmission that is associated with a higher priority level based on the first transmission being a first dynamically scheduled transmission and the second transmission being a second dynamically scheduled transmission.

In some aspects, communicating one of the first transmission or the second transmission via the time interval includes communicating, in accordance with the conflict resolution scheme, the second transmission based on the first communication direction being associated with a higher priority than the second communication direction, the first transmission being a first dynamically scheduled transmission, and the second transmission being a second dynamically scheduled transmission.

In some aspects, communicating one of the first transmission or the second transmission via the time interval includes communicating, in accordance with the conflict resolution scheme, the first transmission based on the second communication direction being associated with a higher priority than the first communication direction, the first transmission being a first dynamically scheduled transmission, and the second transmission being a second dynamically scheduled transmission.

In some aspects receiving the scheduling information includes receiving RRC signaling including the scheduling information.

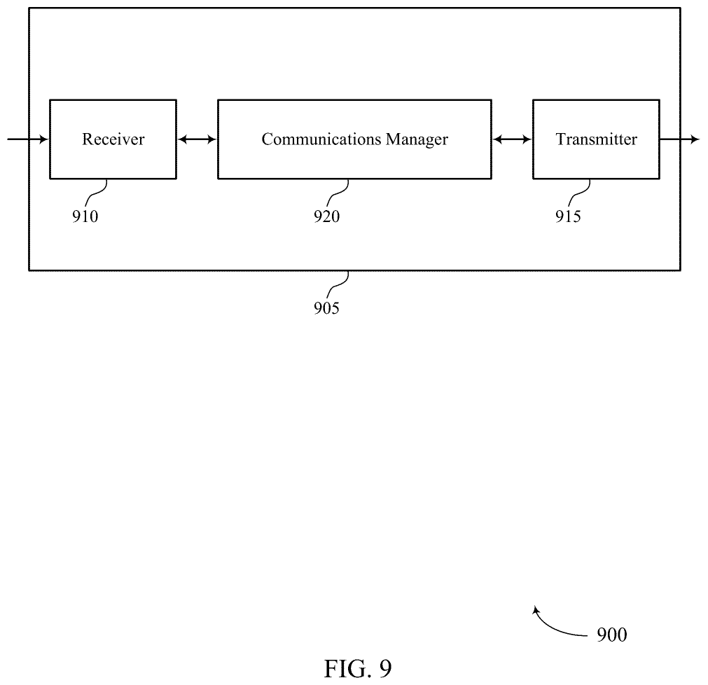

FIG. 9 shows a block diagram 900 of a device 905 that supports collision handling for SBFD aware UEs in accordance with one or more aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to collision handling for SBFD aware UEs). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to collision handling for SBFD aware UEs). In some aspects, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of collision handling for SBFD aware UEs as described herein. For example, the communications manager 920, the receiver 910, the transmitter 915, or various combinations or components thereof may support a method for performing one or more of the functions described herein.

In some aspects, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first network entity in accordance with examples as disclosed herein. For example, the communications manager 920 may be configured as or otherwise support a means for receiving control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network entity. The communications manager 920 may be configured as or otherwise support a means for receiving scheduling information for a first transmission between the first network entity and the second network entity in the time interval and the second set of frequency resources for the time interval, where the scheduling information includes an indication that the first transmission is associated with the second communication direction. The communications manager 920 may be configured as or otherwise support a means for communicating with the second network entity via the time interval in accordance with a conflict resolution scheme based on the time interval being associated with the first communication direction and the first transmission being associated with the second communication direction.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

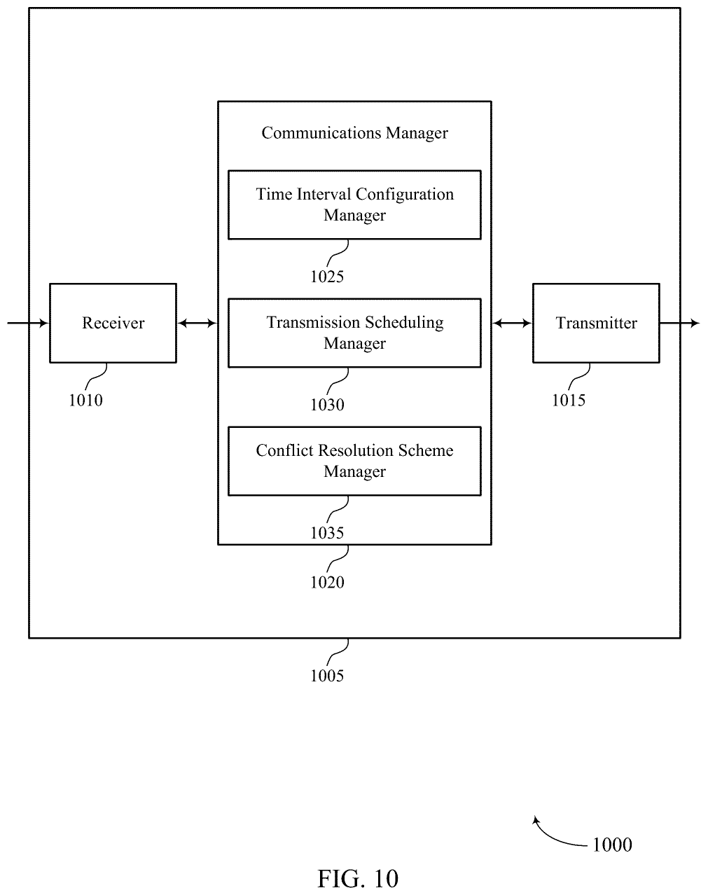

FIG. 10 shows a block diagram 1000 of a device 1005 that supports collision handling for SBFD aware UEs in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to collision handling for SBFD aware UEs). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to collision handling for SBFD aware UEs). In some aspects, the transmitter 1015 may be co-located with a receiver 1010 in a transceiver module. The transmitter 1015 may utilize a single antenna or a set of multiple antennas.

The device 1005, or various components thereof, may be an example of means for performing various aspects of collision handling for SBFD aware UEs as described herein. For example, the communications manager 1020 may include a time interval configuration manager 1025, a transmission scheduling manager 1030, a conflict resolution scheme manager 1035, or any combination thereof. The communications manager 1020 may be an example of aspects of a communications manager 920 as described herein. In some aspects, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first network entity in accordance with examples as disclosed herein. The time interval configuration manager 1025 may be configured as or otherwise support a means for receiving control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network entity. The transmission scheduling manager 1030 may be configured as or otherwise support a means for receiving scheduling information for a first transmission between the first network entity and the second network entity in the time interval and the second set of frequency resources for the time interval, where the scheduling information includes an indication that the first transmission is associated with the second communication direction. The conflict resolution scheme manager 1035 may be configured as or otherwise support a means for communicate with the second network entity via the time interval in accordance with a conflict resolution scheme based on the time interval being associated with the first communication direction and the first transmission being associated with the second communication direction.

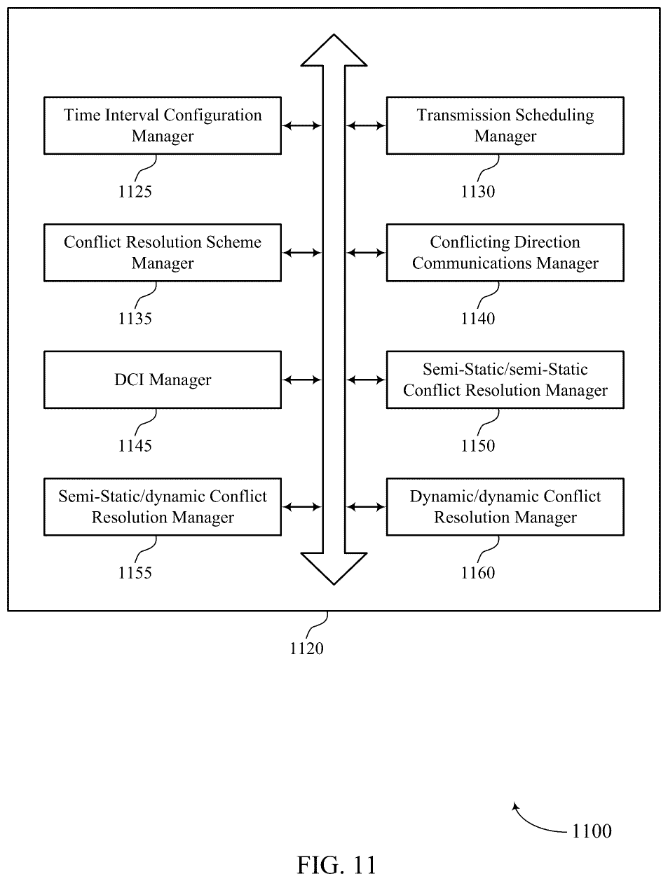

FIG. 11 shows a block diagram 1100 of a communications manager 1120 that supports collision handling for SBFD aware UEs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of collision handling for SBFD aware UEs as described herein. For example, the communications manager 1120 may include a time interval configuration manager 1125, a transmission scheduling manager 1130, a conflict resolution scheme manager 1135, a conflicting direction communications manager 1140, a DCI manager 1145, a semi-static/semi-static conflict resolution manager 1150, a semi-static/dynamic conflict resolution manager 1155, a dynamic/dynamic conflict resolution manager 1160, or any combination thereof. Each of these components may communicate, directly or indirectly, with one another (e.g., via one or more buses).

The communications manager 1120 may support wireless communications at a first network entity in accordance with examples as disclosed herein. The time interval configuration manager 1125 may be configured as or otherwise support a means for receiving control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network entity. The transmission scheduling manager 1130 may be configured as or otherwise support a means for receiving scheduling information for a first transmission between the first network entity and the second network entity in the time interval and the second set of frequency resources for the time interval, where the scheduling information includes an indication that the first transmission is associated with the second communication direction. The conflict resolution scheme manager 1135 may be configured as or otherwise support a means for communicate with the second network entity via the time interval in accordance with a conflict resolution scheme based on the time interval being associated with the first communication direction and the first transmission being associated with the second communication direction.

In some aspects, to support communicating with the second network entity via the time interval, the conflicting direction communications manager 1140 may be configured as or otherwise support a means for communicating, in accordance with the conflict resolution scheme, the first transmission via the time interval and the second set of frequency resources.

In some aspects, the time interval includes a flexible time interval type based on the first transmission being associated with the second communication direction in accordance with the conflict resolution scheme. In some aspects, communicating the first transmission via the time interval and the second set of frequency resources is based on the time interval including the flexible time interval type.

In some aspects, the DCI manager 1145 may be configured as or otherwise support a means for communicating, in accordance with the conflict resolution scheme, the first transmission via the time interval and the second set of frequency resources based on a DCI including the scheduling information, where receiving the scheduling information includes receiving the DCI including the scheduling information.

In some aspects, the transmission scheduling manager 1130 may be configured as or otherwise support a means for receiving second scheduling information for a second transmission between the first network entity and the second network entity in the time interval and the first set of frequency resources for the time interval, where the second scheduling information includes an indication that the second transmission is associated with the first communication direction, and where communicating with the second network entity via the time interval includes communicating one of the first transmission or the second transmission via the time interval in accordance with the conflict resolution scheme.

In some aspects, to support communicating one of the first transmission or the second transmission via the time interval, the semi-static/semi-static conflict resolution manager 1150 may be configured as or otherwise support a means for communicating, in accordance with the conflict resolution scheme, the second transmission based on the second transmission being associated with the first communication direction, the first transmission including a first semi-statically scheduled transmission, and the second transmission including a second semi-statically scheduled transmission.

In some aspects, to support communicating one of the first transmission or the second transmission via the time interval, the semi-static/semi-static conflict resolution manager 1150 may be configured as or otherwise support a means for communicating, in accordance with the conflict resolution scheme, whichever transmission of the first transmission and the second transmission that is associated with a higher priority level based on the first transmission including a first semi-statically scheduled transmission and the second transmission including a second semi-statically scheduled transmission.

In some aspects, to support communicating one of the first transmission or the second transmission via the time interval, the semi-static/semi-static conflict resolution manager 1150 may be configured as or otherwise support a means for communicating, in accordance with the conflict resolution scheme, the first transmission based on the second communication direction being associated with a higher priority than the first communication direction, the first transmission including a first semi-statically scheduled transmission, and the second transmission including a second semi-statically scheduled transmission.

In some aspects, to support communicating one of the first transmission or the second transmission via the time interval, the semi-static/semi-static conflict resolution manager 1150 may be configured as or otherwise support a means for communicating, in accordance with the conflict resolution scheme, the second transmission based on the first communication direction being associated with a higher priority than the second communication direction, the first transmission including a first semi-statically scheduled transmission, and the second transmission including a second semi-statically scheduled transmission.

In some aspects, to support communicating one of the first transmission or the second transmission via the time interval, the semi-static/dynamic conflict resolution manager 1155 may be configured as or otherwise support a means for communicating, in accordance with the conflict resolution scheme, a dynamically scheduled transmission based on the first transmission including a semi-statically scheduled transmission and the second transmission including the dynamically scheduled transmission or the first transmission including the dynamically scheduled transmission and the second transmission including the semi-statically scheduled transmission.

In some aspects, to support communicating one of the first transmission or the second transmission via the time interval, the semi-static/dynamic conflict resolution manager 1155 may be configured as or otherwise support a means for communicating, in accordance with the conflict resolution scheme, the second transmission based on the second transmission being associated with the first communication direction and the first transmission including a semi-statically scheduled transmission and the second transmission including a dynamically scheduled transmission or the first transmission including a dynamically scheduled transmission and the second transmission including a semi-statically scheduled transmission.

In some aspects, to support communicating one of the first transmission or the second transmission via the time interval, the dynamic/dynamic conflict resolution manager 1160 may be configured as or otherwise support a means for communicating, in accordance with the conflict resolution scheme, one of the first transmission or the second transmission based on a timing order in which the scheduling information and the second scheduling information was received, the first transmission including a first dynamically scheduled transmission, and the second transmission including a second dynamically scheduled transmission.

In some aspects, to support communicating one of the first transmission or the second transmission via the time interval, the dynamic/dynamic conflict resolution manager 1160 may be configured as or otherwise support a means for communicating, in accordance with the conflict resolution scheme, one of the first transmission or the second transmission based on a first TDRA, a second TDRA, the first transmission including a first dynamically scheduled transmission, and the second transmission including a second dynamically scheduled transmission, where the scheduling information includes an indication of the first TDRA associated with the first transmission, and where the second scheduling information includes an indication of the second TDRA associated with the second transmission.

In some aspects, to support communicating one of the first transmission or the second transmission via the time interval, the dynamic/dynamic conflict resolution manager 1160 may be configured as or otherwise support a means for communicating, in accordance with the conflict resolution scheme, whichever transmission of the first transmission and the second transmission that is associated with a higher priority level based on the first transmission including a first dynamically scheduled transmission and the second transmission including a second dynamically scheduled transmission.

In some aspects, to support communicating one of the first transmission or the second transmission via the time interval, the dynamic/dynamic conflict resolution manager 1160 may be configured as or otherwise support a means for communicating, in accordance with the conflict resolution scheme, the second transmission based on the first communication direction being associated with a higher priority than the second communication direction, the first transmission including a first dynamically scheduled transmission, and the second transmission including a second dynamically scheduled transmission.

In some aspects, to support communicating one of the first transmission or the second transmission via the time interval, the dynamic/dynamic conflict resolution manager 1160 may be configured as or otherwise support a means for communicating, in accordance with the conflict resolution scheme, the first transmission based on the second communication direction being associated with a higher priority than the first communication direction, the first transmission including a first dynamically scheduled transmission, and the second transmission including a second dynamically scheduled transmission.

In some aspects, receiving the scheduling information includes receiving RRC signaling including the scheduling information.

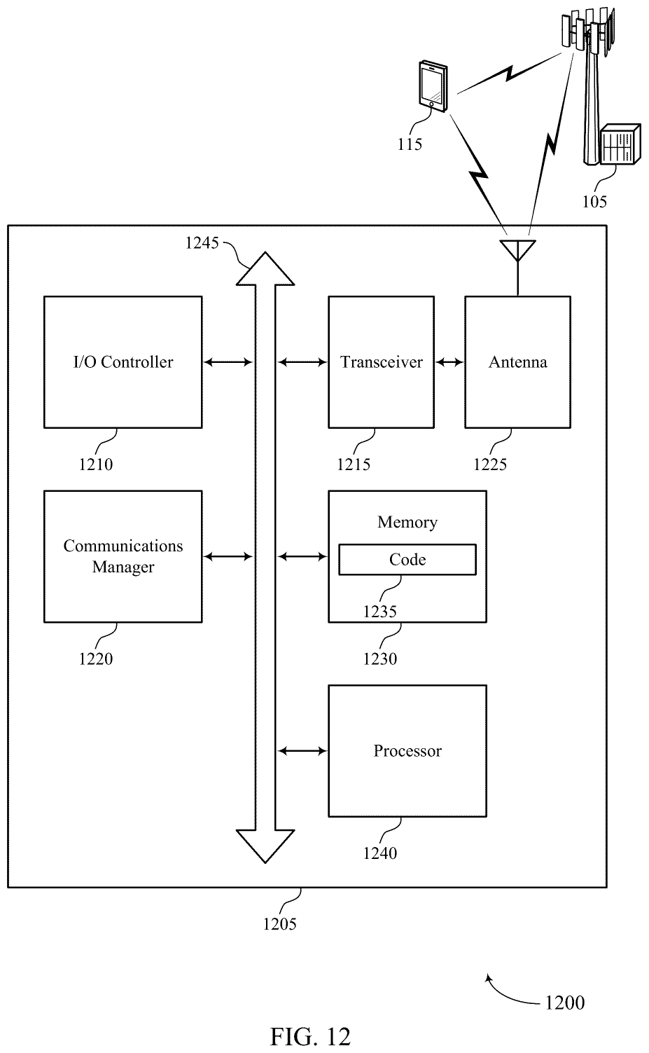

FIG. 12 shows a diagram of a system 1200 including a device 1205 that supports collision handling for SBFD aware UEs in accordance with one or more aspects of the present disclosure. The device 1205 may be an example of or include the components of a device 905, a device 1005, or a UE 115 as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting collision handling for SBFD aware UEs). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a first network entity in accordance with examples as disclosed herein. For example, the communications manager 1220 may be configured as or otherwise support a means for receiving control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network entity. The communications manager 1220 may be configured as or otherwise support a means for receiving scheduling information for a first transmission between the first network entity and the second network entity in the time interval and the second set of frequency resources for the time interval, where the scheduling information includes an indication that the first transmission is associated with the second communication direction. The communications manager 1220 may be configured as or otherwise support a means for communicating with the second network entity via the time interval in accordance with a conflict resolution scheme based on the time interval being associated with the first communication direction and the first transmission being associated with the second communication direction.

By including or configuring the communications manager 1220 in accordance with examples as described herein, the device 1205 may support techniques for improved communication reliability and more efficient utilization of communication resources.

In some aspects, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some aspects, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of collision handling for SBFD aware UEs as described herein, or the processor 1240 and the memory 1230 may be otherwise configured to perform or support such operations.

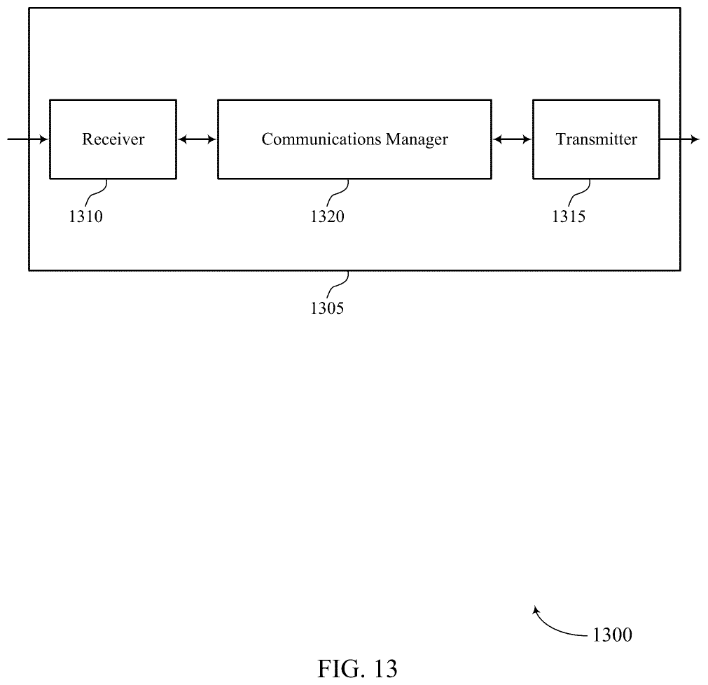

FIG. 13 shows a block diagram 1300 of a device 1305 that supports collision handling for SBFD aware UEs in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., UQ samples, symbols, packets, protocol data units, service data units) associated with various channels (e.g., control channels, data channels, information channels, channels associated with a protocol stack). Information may be passed on to other components of the device 1305. In some aspects, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., UQ samples, symbols, packets, protocol data units, service data units) associated with various channels (e.g., control channels, data channels, information channels, channels associated with a protocol stack). In some aspects, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some aspects, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of collision handling for SBFD aware UEs as described herein. For example, the communications manager 1320, the receiver 1310, the transmitter 1315, or various combinations or components thereof may support a method for performing one or more of the functions described herein.

In some aspects, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a first network entity in accordance with examples as disclosed herein. For example, the communications manager 1320 may be configured as or otherwise support a means for transmitting control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity. The communications manager 1320 may be configured as or otherwise support a means for transmitting scheduling information for a first transmission between the first network entity and the second network entity in the time interval and the second set of frequency resources for the time interval, where the scheduling information includes an indication that the first transmission is associated with the second communication direction. The communications manager 1320 may be configured as or otherwise support a means for communicating with the second network entity via the time interval in accordance with a conflict resolution scheme based on the time interval being associated with the first communication direction and the first transmission being associated with the second communication direction.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for more efficient utilization of communication resources.

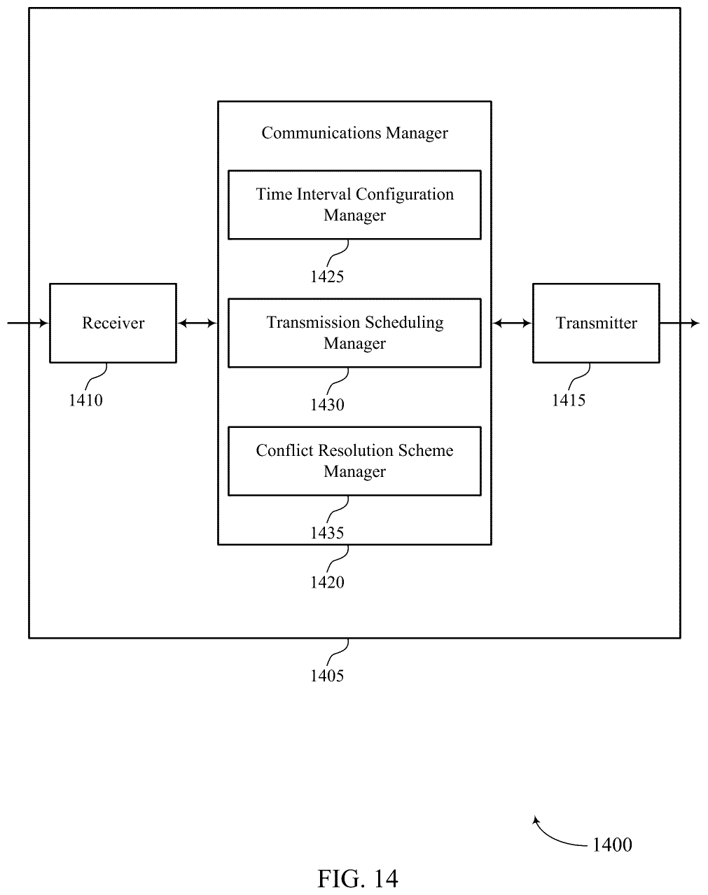

FIG. 14 shows a block diagram 1400 of a device 1405 that supports collision handling for SBFD aware UEs in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., UQ samples, symbols, packets, protocol data units, service data units) associated with various channels (e.g., control channels, data channels, information channels, channels associated with a protocol stack). Information may be passed on to other components of the device 1405. In some aspects, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., UQ samples, symbols, packets, protocol data units, service data units) associated with various channels (e.g., control channels, data channels, information channels, channels associated with a protocol stack). In some aspects, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some aspects, the transmitter 1415 and the receiver 1410 may be co-located in a transceiver, which may include or be coupled with a modem.

The device 1405, or various components thereof, may be an example of means for performing various aspects of collision handling for SBFD aware UEs as described herein. For example, the communications manager 1420 may include a time interval configuration manager 1425, a transmission scheduling manager 1430, a conflict resolution scheme manager 1435, or any combination thereof. The communications manager 1420 may be an example of aspects of a communications manager 1320 as described herein. In some aspects, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a first network entity in accordance with examples as disclosed herein. The time interval configuration manager 1425 may be configured as or otherwise support a means for transmitting control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity. The transmission scheduling manager 1430 may be configured as or otherwise support a means for transmitting scheduling information for a first transmission between the first network entity and the second network entity in the time interval and the second set of frequency resources for the time interval, where the scheduling information includes an indication that the first transmission is associated with the second communication direction. The conflict resolution scheme manager 1435 may be configured as or otherwise support a means for communicating with the second network entity via the time interval in accordance with a conflict resolution scheme based on the time interval being associated with the first communication direction and the first transmission being associated with the second communication direction.

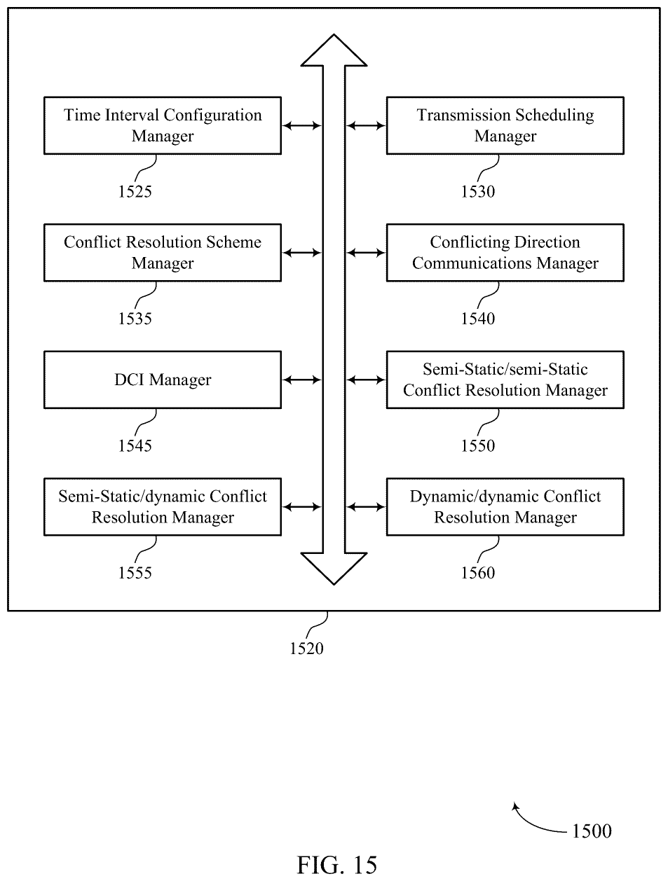

FIG. 15 shows a block diagram 1500 of a communications manager 1520 that supports collision handling for SBFD aware UEs in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of collision handling for SBFD aware UEs as described herein. For example, the communications manager 1520 may include a time interval configuration manager 1525, a transmission scheduling manager 1530, a conflict resolution scheme manager 1535, a conflicting direction communications manager 1540, a DCI manager 1545, a semi-static/semi-static conflict resolution manager 1550, a semi-static/dynamic conflict resolution manager 1555, a dynamic/dynamic conflict resolution manager 1560, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications at a first network entity in accordance with examples as disclosed herein. The time interval configuration manager 1525 may be configured as or otherwise support a means for transmitting control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity. The transmission scheduling manager 1530 may be configured as or otherwise support a means for transmitting scheduling information for a first transmission between the first network entity and the second network entity in the time interval and the second set of frequency resources for the time interval, where the scheduling information includes an indication that the first transmission is associated with the second communication direction. The conflict resolution scheme manager 1535 may be configured as or otherwise support a means for communicating with the second network entity via the time interval in accordance with a conflict resolution scheme based on the time interval being associated with the first communication direction and the first transmission being associated with the second communication direction.

In some aspects, to support communicating with the second network entity via the time interval, the conflicting direction communications manager 1540 may be configured as or otherwise support a means for communicating, in accordance with the conflict resolution scheme, the first transmission via the time interval and the second set of frequency resources.

In some aspects, the time interval includes a flexible time interval type based on the first transmission being associated with the second communication direction in accordance with the conflict resolution scheme. In some aspects, communicating the first transmission via the time interval and the second set of frequency resources is based on the time interval including the flexible time interval type.

In some aspects, the DCI manager 1545 may be configured as or otherwise support a means for communicating, in accordance with the conflict resolution scheme, the first transmission via the time interval and the second set of frequency resources based on a DCI including the scheduling information, where transmitting the scheduling information includes transmitting the DCI including the scheduling information.

In some aspects, the transmission scheduling manager 1530 may be configured as or otherwise support a means for transmitting second scheduling information for a second transmission between the first network entity and the second network entity in the time interval and the first set of frequency resources for the time interval, where the second scheduling information includes an indication that the second transmission is associated with the first communication direction, and where communicating with the second network entity via the time interval includes communicating one of the first transmission or the second transmission via the time interval in accordance with the conflict resolution scheme.

In some aspects, to support communicating one of the first transmission or the second transmission via the time interval, the semi-static/semi-static conflict resolution manager 1550 may be configured as or otherwise support a means for communicating, in accordance with the conflict resolution scheme, the second transmission based on the second transmission being associated with the first communication direction, the first transmission including a first semi-statically scheduled transmission, and the second transmission including a second semi-statically scheduled transmission.

In some aspects, to support communicating one of the first transmission or the second transmission via the time interval, the semi-static/semi-static conflict resolution manager 1550 may be configured as or otherwise support a means for communicating, in accordance with the conflict resolution scheme, whichever transmission of the first transmission and the second transmission that is associated with a higher priority level based on the first transmission including a first semi-statically scheduled transmission and the second transmission including a second semi-statically scheduled transmission.

In some aspects, to support communicating one of the first transmission or the second transmission via the time interval, the semi-static/semi-static conflict resolution manager 1550 may be configured as or otherwise support a means for communicating, in accordance with the conflict resolution scheme, the first transmission based on the second communication direction being associated with a higher priority than the first communication direction, the first transmission including a first semi-statically scheduled transmission, and the second transmission including a second semi-statically scheduled transmission.

In some aspects, to support communicating one of the first transmission or the second transmission via the time interval, the semi-static/semi-static conflict resolution manager 1550 may be configured as or otherwise support a means for communicating, in accordance with the conflict resolution scheme, the second transmission based on the first communication direction being associated with a higher priority than the second communication direction, the first transmission including a first semi-statically scheduled transmission, and the second transmission including a second semi-statically scheduled transmission.

In some aspects, to support communicating one of the first transmission or the second transmission via the time interval, the semi-static/dynamic conflict resolution manager 1555 may be configured as or otherwise support a means for communicating, in accordance with the conflict resolution scheme, a dynamically scheduled transmission based on the first transmission including a semi-statically scheduled transmission and the second transmission including the dynamically scheduled transmission or the first transmission including the dynamically scheduled transmission and the second transmission including the semi-statically scheduled transmission.

In some aspects, to support communicating one of the first transmission or the second transmission via the time interval, the semi-static/dynamic conflict resolution manager 1555 may be configured as or otherwise support a means for communicating, in accordance with the conflict resolution scheme, the second transmission based on the second transmission being associated with the first communication direction and the first transmission including a semi-statically scheduled transmission and the second transmission including a dynamically scheduled transmission or the first transmission including a dynamically scheduled transmission and the second transmission including a semi-statically scheduled transmission.

In some aspects, to support communicating one of the first transmission or the second transmission via the time interval, the dynamic/dynamic conflict resolution manager 1560 may be configured as or otherwise support a means for communicating, in accordance with the conflict resolution scheme, one of the first transmission or the second transmission based on a timing order in which the scheduling information and the second scheduling information was transmitted, the first transmission including a first dynamically scheduled transmission, and the second transmission including a second dynamically scheduled transmission.

In some aspects, to support communicating one of the first transmission or the second transmission via the time interval, the dynamic/dynamic conflict resolution manager 1560 may be configured as or otherwise support a means for communicating, in accordance with the conflict resolution scheme, one of the first transmission or the second transmission based on a first TDRA, a second TDRA, the first transmission including a first dynamically scheduled transmission, and the second transmission including a second dynamically scheduled transmission, where the scheduling information includes an indication of the first TDRA associated with the first transmission, and where the second scheduling information includes an indication of the second TDRA associated with the second transmission.

In some aspects, to support communicating one of the first transmission or the second transmission via the time interval, the dynamic/dynamic conflict resolution manager 1560 may be configured as or otherwise support a means for communicating, in accordance with the conflict resolution scheme, whichever transmission of the first transmission and the second transmission that is associated with a higher priority level based on the first transmission including a first dynamically scheduled transmission and the second transmission including a second dynamically scheduled transmission.

In some aspects, to support communicating one of the first transmission or the second transmission via the time interval, the dynamic/dynamic conflict resolution manager 1560 may be configured as or otherwise support a means for communicating, in accordance with the conflict resolution scheme, the second transmission based on the first communication direction being associated with a higher priority than the second communication direction, the first transmission including a first dynamically scheduled transmission, and the second transmission including a second dynamically scheduled transmission.

In some aspects, to support communicating one of the first transmission or the second transmission via the time interval, the dynamic/dynamic conflict resolution manager 1560 may be configured as or otherwise support a means for communicating, in accordance with the conflict resolution scheme, the first transmission based on the second communication direction being associated with a higher priority than the first communication direction, the first transmission including a first dynamically scheduled transmission, and the second transmission including a second dynamically scheduled transmission.

In some aspects, transmitting the scheduling information includes transmitting RRC signaling including the scheduling information.

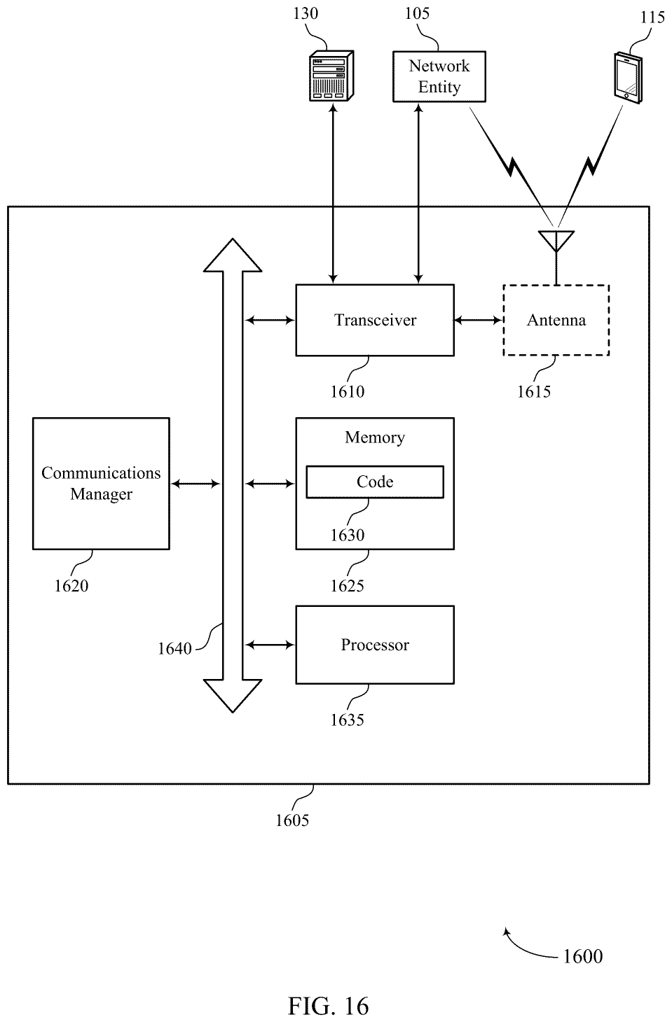

FIG. 16 shows a diagram of a system 1600 including a device 1605 that supports collision handling for SBFD aware UEs in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some aspects, the transceiver 1610 may include a wired transceiver and may communicate bi-directionally with another wired transceiver. Additionally, or alternatively, in some aspects, the transceiver 1610 may include a wireless transceiver and may communicate bi-directionally with another wireless transceiver. In some aspects, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some aspects, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting collision handling for SBFD aware UEs). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may generally refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605, and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some aspects, a bus 1640 may support communications of (e.g., within) a protocol layer of a protocol stack. In some aspects, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some aspects, the communications manager 1620 may manage aspects of communications with a core network 130 (e.g., via one or more wired or wireless backhaul links). For example, the communications manager 1620 may manage the transfer of data communications for client devices, such as one or more UEs 115. In some aspects, the communications manager 1620 may manage communications with other network entities 105, and may include a controller or scheduler for controlling communications with UEs 115 in cooperation with other network entities 105. In some aspects, the communications manager 1620 may support an X2 interface within an LTE/LTE-A wireless communications network technology to provide communication between network entities 105.

The communications manager 1620 may support wireless communications at a first network entity in accordance with examples as disclosed herein. For example, the communications manager 1620 may be configured as or otherwise support a means for transmitting control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity. The communications manager 1620 may be configured as or otherwise support a means for transmitting scheduling information for a first transmission between the first network entity and the second network entity in the time interval and the second set of frequency resources for the time interval, where the scheduling information includes an indication that the first transmission is associated with the second communication direction. The communications manager 1620 may be configured as or otherwise support a means for communicating with the second network entity via the time interval in accordance with a conflict resolution scheme based on the time interval being associated with the first communication direction and the first transmission being associated with the second communication direction.

By including or configuring the communications manager 1620 in accordance with examples as described herein, the device 1605 may support techniques for improved communication reliability and more efficient utilization of communication resources.

In some aspects, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some aspects, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of collision handling for SBFD aware UEs as described herein, or the processor 1635 and the memory 1625 may be otherwise configured to perform or support such operations.

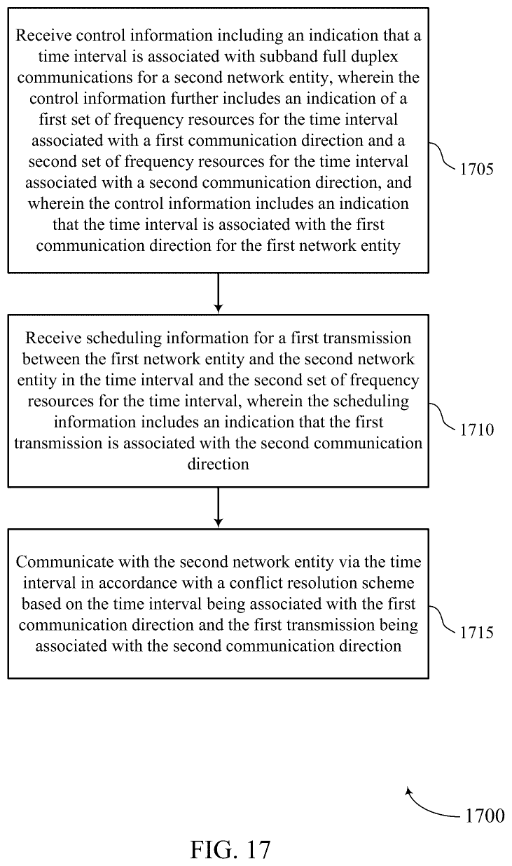

FIG. 17 shows a flowchart illustrating a method 1700 that supports collision handling for SBFD aware UEs in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some aspects, a UE may execute a set of instructions to control the functional elements of the UE to perform the described functions. Additionally, or alternatively, the UE may perform aspects of the described functions using special-purpose hardware.

At 1705, the method may include receiving control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network entity. The operations of 1705 may be performed in accordance with examples as disclosed herein. In some aspects, aspects of the operations of 1705 may be performed by a time interval configuration manager 1125 as described with reference to FIG. 11.

At 1710, the method may include receiving scheduling information for a first transmission between the first network entity and the second network entity in the time interval and the second set of frequency resources for the time interval, where the scheduling information includes an indication that the first transmission is associated with the second communication direction. The operations of 1710 may be performed in accordance with examples as disclosed herein. In some aspects, aspects of the operations of 1710 may be performed by a transmission scheduling manager 1130 as described with reference to FIG. 11.

At 1715, the method may include communicate with the second network entity via the time interval in accordance with a conflict resolution scheme based on the time interval being associated with the first communication direction and the first transmission being associated with the second communication direction. The operations of 1715 may be performed in accordance with examples as disclosed herein. In some aspects, aspects of the operations of 1715 may be performed by a conflict resolution scheme manager 1135 as described with reference to FIG. 11.

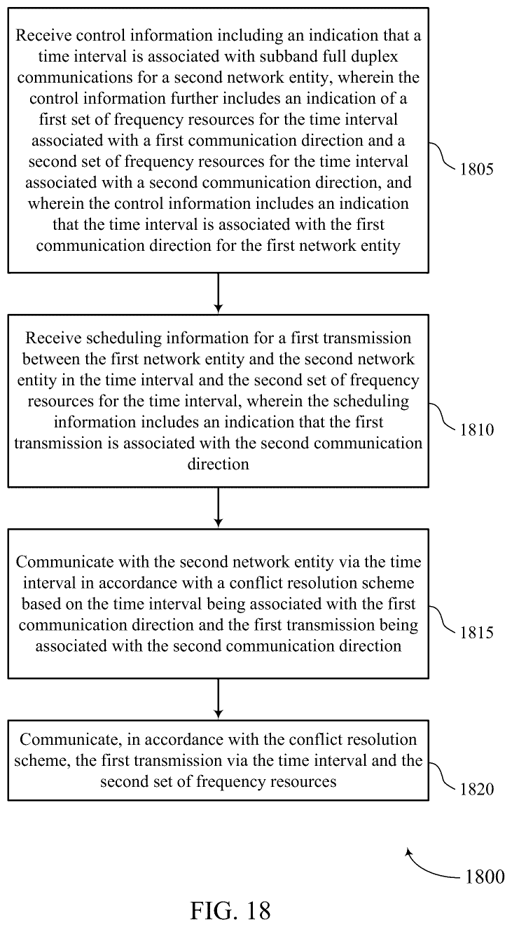

FIG. 18 shows a flowchart illustrating a method 1800 that supports collision handling for SBFD aware UEs in accordance with one or more aspects of the present disclosure. The operations of the method 1800 may be implemented by a UE or its components as described herein. For example, the operations of the method 1800 may be performed by a UE 115 as described with reference to FIGS. 1 through 12. In some aspects, a UE may execute a set of instructions to control the functional elements of the UE to perform the described functions. Additionally, or alternatively, the UE may perform aspects of the described functions using special-purpose hardware.

At 1805, the method may include receiving control information including an indication that a time interval is associated with SBFD communications for a second network entity, where the control information further includes an indication of a first set of frequency resources for the time interval associated with a first communication direction and a second set of frequency resources for the time interval associated with a second communication direction, and where the control information includes an indication that the time interval is associated with the first communication direction for the first network n entity ode. The operations of 1805 may be performed in accordance with examples as disclosed herein. In some aspects, aspects of the operations of 1805 may be performed by a time interval configuration manager 1125 as described with reference to FIG. 11.

At 1810, the method may include receiving scheduling information for a first transmission between the first network entity and the second network entity in the time interval and the second set of frequency resources for the time interval, where the scheduling information includes an indication that the first transmission is associated with the second communication direction. The operations of 1810 may be performed in accordance with examples as disclosed herein. In some aspects, aspects of the operations of 1810 may be performed by a transmission scheduling manager 1130 as described with reference to FIG. 11.

At 1815, the method may include communicate with the second network entity via the time interval in accordance with a conflict resolution scheme based on the time interval being associated with the first communication direction and the first transmission being associated with the second communication direction. The operations of 1815 may be performed in accordance with examples as disclosed herein. In some aspects, aspects of the operations of 1815 may be performed by a conflict resolution scheme manager 1135 as described with reference to FIG. 11.

At 1820, the method may include communicating, in accordance with the conflict resolution scheme, the first transmission via the time interval and the second set of frequency resources. The operations of 1820 may be performed in accordance with examples as disclosed herein. In some aspects, aspects of the operations of 1820 may be performed by a conflicting direction communications manager 1140 as described with reference to FIG. 11.

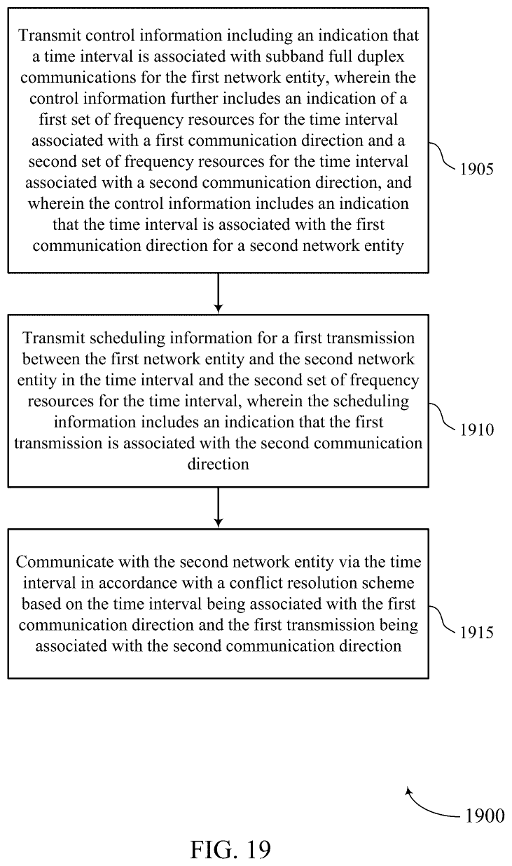

FIG. 19 shows a flowchart illustrating a method 1900 that supports collision handling for SBFD aware UEs in accordance with one or more aspects of the present disclosure. The operations of the method 1900 may be implemented by a network entity or its components as described herein. For example, the operations of the method 1900 may be performed by a network entity as described with reference to FIGS. 1 through 8 and 13 through 16. In some aspects, a network entity may execute a set of instructions to control the functional elements of the network entity to perform the described functions. Additionally, or alternatively, the network entity may perform aspects of the described functions using special-purpose hardware.

At 1905, the method may include transmitting control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity. The operations of 1905 may be performed in accordance with examples as disclosed herein. In some aspects, aspects of the operations of 1905 may be performed by a time interval configuration manager 1525 as described with reference to FIG. 15.

At 1910, the method may include transmitting scheduling information for a first transmission between the first network entity and the second network entity in the time interval and the second set of frequency resources for the time interval, where the scheduling information includes an indication that the first transmission is associated with the second communication direction. The operations of 1910 may be performed in accordance with examples as disclosed herein. In some aspects, aspects of the operations of 1910 may be performed by a transmission scheduling manager 1530 as described with reference to FIG. 15.

At 1915, the method may include communicating with the second network entity via the time interval in accordance with a conflict resolution scheme based on the time interval being associated with the first communication direction and the first transmission being associated with the second communication direction. The operations of 1915 may be performed in accordance with examples as disclosed herein. In some aspects, aspects of the operations of 1915 may be performed by a conflict resolution scheme manager 1535 as described with reference to FIG. 15.

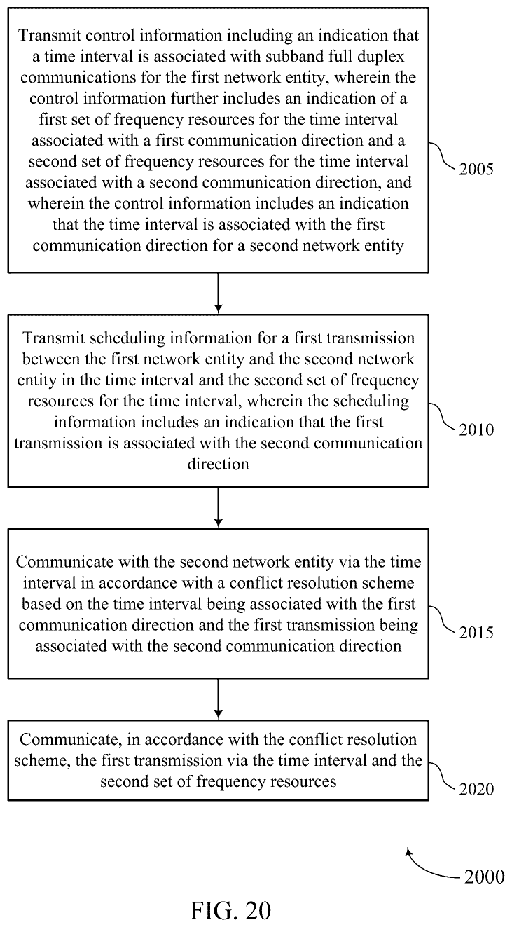

FIG. 20 shows a flowchart illustrating a method 2000 that supports collision handling for SBFD aware UEs in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some aspects, a network entity may execute a set of instructions to control the functional elements of the network entity to perform the described functions. Additionally, or alternatively, the network entity may perform aspects of the described functions using special-purpose hardware.

At 2005, the method may include transmitting control information including an indication that a time interval is associated with SBFD communications for the first network entity, where the control information further includes an indication of a first set of frequency resources for the time interval associated with a first communication direction and a second set of frequency resources for the time interval associated with a second communication direction, and where the control information includes an indication that the time interval is associated with the first communication direction for a second network entity. The operations of 2005 may be performed in accordance with examples as disclosed herein. In some aspects, aspects of the operations of 2005 may be performed by a time interval configuration manager 1525 as described with reference to FIG. 15.

At 2010, the method may include transmitting scheduling information for a first transmission between the first network entity and the second network entity in the time interval and the second set of frequency resources for the time interval, where the scheduling information includes an indication that the first transmission is associated with the second communication direction. The operations of 2010 may be performed in accordance with examples as disclosed herein. In some aspects, aspects of the operations of 2010 may be performed by a transmission scheduling manager 1530 as described with reference to FIG. 15.

At 2015, the method may include communicating with the second network entity via the time interval in accordance with a conflict resolution scheme based on the time interval being associated with the first communication direction and the first transmission being associated with the second communication direction. The operations of 2015 may be performed in accordance with examples as disclosed herein. In some aspects, aspects of the operations of 2015 may be performed by a conflict resolution scheme manager 1535 as described with reference to FIG. 15.

At 2020, the method may include communicating, in accordance with the conflict resolution scheme, the first transmission via the time interval and the second set of frequency resources. The operations of 2020 may be performed in accordance with examples as disclosed herein. In some aspects, aspects of the operations of 2020 may be performed by a conflicting direction communications manager 1540 as described with reference to FIG. 15.

The following provides an overview of aspects of the present disclosure:

Aspect 1: A method for wireless communications at a first network entity, comprising: receiving control information including an indication that a time interval is associated with SBFD communications for a second network entity, wherein the control information further includes an indication of a first set of frequency resources for the time interval associated with a first communication direction and a second set of frequency resources for the time interval associated with a second communication direction, and wherein the control information includes an indication that the time interval is associated with the first communication direction for the first network entity; receiving scheduling information for a first transmission between the first network entity and the second network entity in the time interval and the second set of frequency resources for the time interval, wherein the scheduling information includes an indication that the first transmission is associated with the second communication direction; and communicate with the second network entity via the time interval in accordance with a conflict resolution scheme based on the time interval being associated with the first communication direction and the first transmission being associated with the second communication direction.

Aspect 2: The method of aspect 1, wherein communicating with the second network entity via the time interval comprises: communicating, in accordance with the conflict resolution scheme, the first transmission via the time interval and the second set of frequency resources.

Aspect 3: The method of aspect 2, wherein the time interval comprises a flexible time interval type based on the first transmission being associated with the second communication direction in accordance with the conflict resolution scheme, and communicating the first transmission via the time interval and the second set of frequency resources is based on the time interval comprising the flexible time interval type.

Aspect 4: The method of any of aspects 1 through 3, further comprising: communicating, in accordance with the conflict resolution scheme, the first transmission via the time interval and the second set of frequency resources based on a DCI including the scheduling information, wherein receiving the scheduling information comprises receiving the DCI including the scheduling information.

Aspect 5: The method of any of aspects 1 through 4, further comprising: receiving second scheduling information for a second transmission between the first network entity and the second network entity in the time interval and the first set of frequency resources for the time interval, wherein the second scheduling information includes an indication that the second transmission is associated with the first communication direction, and wherein communicating with the second network entity via the time interval comprises communicating one of the first transmission or the second transmission via the time interval in accordance with the conflict resolution scheme.

Aspect 6: The method of aspect 5, wherein communicating one of the first transmission or the second transmission via the time interval comprises: communicating, in accordance with the conflict resolution scheme, the second transmission based on the second transmission being associated with the first communication direction, the first transmission comprising a first semi-statically scheduled transmission, and the second transmission comprising a second semi-statically scheduled transmission.

Aspect 7: The method of aspect 5, wherein communicating one of the first transmission or the second transmission via the time interval comprises: communicating, in accordance with the conflict resolution scheme, whichever transmission of the first transmission and the second transmission that is associated with a higher priority level based on the first transmission comprising a first semi-statically scheduled transmission and the second transmission comprising a second semi-statically scheduled transmission.

Aspect 8: The method of aspect 5, wherein communicating one of the first transmission or the second transmission via the time interval comprises: communicating, in accordance with the conflict resolution scheme, the first transmission based on the second communication direction being associated with a higher priority than the first communication direction, the first transmission comprising a first semi-statically scheduled transmission, and the second transmission comprising a second semi-statically scheduled transmission.

Aspect 9: The method of aspect 5, wherein communicating one of the first transmission or the second transmission via the time interval comprises: communicating, in accordance with the conflict resolution scheme, the second transmission based on the first communication direction being associated with a higher priority than the second communication direction, the first transmission comprising a first semi-statically scheduled transmission, and the second transmission comprising a second semi-statically scheduled transmission.

Aspect 10: The method of aspect 5, wherein communicating one of the first transmission or the second transmission via the time interval comprises: communicating, in accordance with the conflict resolution scheme, a dynamically scheduled transmission based on the first transmission comprising a semi-statically scheduled transmission and the second transmission comprising the dynamically scheduled transmission or the first transmission comprising the dynamically scheduled transmission and the second transmission comprising the semi-statically scheduled transmission.

Aspect 11: The method of aspect 5, wherein communicating one of the first transmission or the second transmission via the time interval comprises: communicating, in accordance with the conflict resolution scheme, the second transmission based on the second transmission being associated with the first communication direction and the first transmission comprising a semi-statically scheduled transmission and the second transmission comprising a dynamically scheduled transmission or the first transmission comprising a dynamically scheduled transmission and the second transmission comprising a semi-statically scheduled transmission.

Aspect 12: The method of aspect 5, wherein communicating one of the first transmission or the second transmission via the time interval comprises: communicating, in accordance with the conflict resolution scheme, one of the first transmission or the second transmission based on a timing order in which the scheduling information and the second scheduling information was received, the first transmission comprising a first dynamically scheduled transmission, and the second transmission comprising a second dynamically scheduled transmission.

Aspect 13: The method of aspect 5, wherein communicating one of the first transmission or the second transmission via the time interval comprises: communicating, in accordance with the conflict resolution scheme, one of the first transmission or the second transmission based on a first TDRA, a second TDRA, the first transmission comprising a first dynamically scheduled transmission, and the second transmission comprising a second dynamically scheduled transmission, wherein the scheduling information includes an indication of the first TDRA associated with the first transmission, and wherein the second scheduling information includes an indication of the second TDRA associated with the second transmission.

Aspect 14: The method of aspect 5, wherein communicating one of the first transmission or the second transmission via the time interval comprises: communicating, in accordance with the conflict resolution scheme, whichever transmission of the first transmission and the second transmission that is associated with a higher priority level based on the first transmission comprising a first dynamically scheduled transmission and the second transmission comprising a second dynamically scheduled transmission.

Aspect 15: The method of aspect 5, wherein communicating one of the first transmission or the second transmission via the time interval comprises: communicating, in accordance with the conflict resolution scheme, the second transmission based on the first communication direction being associated with a higher priority than the second communication direction, the first transmission comprising a first dynamically scheduled transmission, and the second transmission comprising a second dynamically scheduled transmission.

Aspect 16: The method of aspect 5, wherein communicating one of the first transmission or the second transmission via the time interval comprises: communicating, in accordance with the conflict resolution scheme, the first transmission based on the second communication direction being associated with a higher priority than the first communication direction, the first transmission comprising a first dynamically scheduled transmission, and the second transmission comprising a second dynamically scheduled transmission.

Aspect 17: The method of any of aspects 1 through 16, wherein receiving the scheduling information comprises receiving RRC signaling including the scheduling information.

Aspect 18: A method for wireless communications at a first network entity, comprising: transmitting control information including an indication that a time interval is associated with SBFD communications for the first network entity, wherein the control information further includes an indication of a first set of frequency resources for the time interval associated with a first communication direction and a second set of frequency resources for the time interval associated with a second communication direction, and wherein the control information includes an indication that the time interval is associated with the first communication direction for a second network entity; transmitting scheduling information for a first transmission between the first network entity and the second network entity in the time interval and the second set of frequency resources for the time interval, wherein the scheduling information includes an indication that the first transmission is associated with the second communication direction; and communicating with the second network entity via the time interval in accordance with a conflict resolution scheme based on the time interval being associated with the first communication direction and the first transmission being associated with the second communication direction.

Aspect 19: The method of aspect 18, wherein communicating with the second network entity via the time interval comprises: communicating, in accordance with the conflict resolution scheme, the first transmission via the time interval and the second set of frequency resources.

Aspect 20: The method of aspect 19, wherein the time interval comprises a flexible time interval type based on the first transmission being associated with the second communication direction in accordance with the conflict resolution scheme, and communicating the first transmission via the time interval and the second set of frequency resources is based on the time interval comprising the flexible time interval type.

Aspect 21: The method of any of aspects 18 through 20, further comprising: communicating, in accordance with the conflict resolution scheme, the first transmission via the time interval and the second set of frequency resources based on a DCI including the scheduling information, wherein transmitting the scheduling information comprises transmitting the DCI including the scheduling information.

Aspect 22: The method of any of aspects 18 through 21, further comprising: transmitting second scheduling information for a second transmission between the first network entity and the second network entity in the time interval and the first set of frequency resources for the time interval, wherein the second scheduling information includes an indication that the second transmission is associated with the first communication direction, and wherein communicating with the second network entity via the time interval comprises communicating one of the first transmission or the second transmission via the time interval in accordance with the conflict resolution scheme.

Aspect 23: The method of aspect 22, wherein communicating one of the first transmission or the second transmission via the time interval comprises: communicating, in accordance with the conflict resolution scheme, the second transmission based on the second transmission being associated with the first communication direction, the first transmission comprising a first semi-statically scheduled transmission, and the second transmission comprising a second semi-statically scheduled transmission.

Aspect 24: The method of aspect 22, wherein communicating one of the first transmission or the second transmission via the time interval comprises: communicating, in accordance with the conflict resolution scheme, whichever transmission of the first transmission and the second transmission that is associated with a higher priority level based on the first transmission comprising a first semi-statically scheduled transmission and the second transmission comprising a second semi-statically scheduled transmission.

Aspect 25: The method of aspect 22, wherein communicating one of the first transmission or the second transmission via the time interval comprises: communicating, in accordance with the conflict resolution scheme, the first transmission based on the second communication direction being associated with a higher priority than the first communication direction, the first transmission comprising a first semi-statically scheduled transmission, and the second transmission comprising a second semi-statically scheduled transmission.

Aspect 26: The method of aspect 22, wherein communicating one of the first transmission or the second transmission via the time interval comprises: communicating, in accordance with the conflict resolution scheme, the second transmission based on the first communication direction being associated with a higher priority than the second communication direction, the first transmission comprising a first semi-statically scheduled transmission, and the second transmission comprising a second semi-statically scheduled transmission.

Aspect 27: The method of aspect 22, wherein communicating one of the first transmission or the second transmission via the time interval comprises: communicating, in accordance with the conflict resolution scheme, a dynamically scheduled transmission based on the first transmission comprising a semi-statically scheduled transmission and the second transmission comprising the dynamically scheduled transmission or the first transmission comprising the dynamically scheduled transmission and the second transmission comprising the semi-statically scheduled transmission.

Aspect 28: The method of aspect 22, wherein communicating one of the first transmission or the second transmission via the time interval comprises: communicating, in accordance with the conflict resolution scheme, the second transmission based on the second transmission being associated with the first communication direction and the first transmission comprising a semi-statically scheduled transmission and the second transmission comprising a dynamically scheduled transmission or the first transmission comprising a dynamically scheduled transmission and the second transmission comprising a semi-statically scheduled transmission.

Aspect 29: The method of aspect 22, wherein communicating one of the first transmission or the second transmission via the time interval comprises: communicating, in accordance with the conflict resolution scheme, one of the first transmission or the second transmission based on a timing order in which the scheduling information and the second scheduling information was transmitted, the first transmission comprising a first dynamically scheduled transmission, and the second transmission comprising a second dynamically scheduled transmission.

Aspect 30: The method of aspect 22, wherein communicating one of the first transmission or the second transmission via the time interval comprises: communicating, in accordance with the conflict resolution scheme, one of the first transmission or the second transmission based on a first TDRA, a second TDRA, the first transmission comprising a first dynamically scheduled transmission, and the second transmission comprising a second dynamically scheduled transmission, wherein the scheduling information includes an indication of the first TDRA associated with the first transmission, and wherein the second scheduling information includes an indication of the second TDRA associated with the second transmission.

Aspect 31: The method of aspect 22, wherein communicating one of the first transmission or the second transmission via the time interval comprises: communicating, in accordance with the conflict resolution scheme, whichever transmission of the first transmission and the second transmission that is associated with a higher priority level based on the first transmission comprising a first dynamically scheduled transmission and the second transmission comprising a second dynamically scheduled transmission.

Aspect 32: The method of aspect 22, wherein communicating one of the first transmission or the second transmission via the time interval comprises: communicating, in accordance with the conflict resolution scheme, the second transmission based on the first communication direction being associated with a higher priority than the second communication direction, the first transmission comprising a first dynamically scheduled transmission, and the second transmission comprising a second dynamically scheduled transmission.

Aspect 33: The method of aspect 22, wherein communicating one of the first transmission or the second transmission via the time interval comprises: communicating, in accordance with the conflict resolution scheme, the first transmission based on the second communication direction being associated with a higher priority than the first communication direction, the first transmission comprising a first dynamically scheduled transmission, and the second transmission comprising a second dynamically scheduled transmission.

Aspect 34: The method of any of aspects 18 through 33, wherein transmitting the scheduling information comprises transmitting RRC signaling including the scheduling information.

Aspect 35: A first network entity for wireless communications, comprising at least one communication interface; and a least one processor coupled to the at least one communication interface, wherein the first network entity is configured to perform a method of any of aspects 1 through 17.

Aspect 36: An apparatus for wireless communications at a first network entity, comprising at least one means for performing a method of any of aspects 1 through 17.

Aspect 37: A non-transitory computer-readable medium having code for wireless communication stored thereon that, when executed by a first network entity, causes the first network entity to perform a method of any of aspects 1 through 17.

Aspect 38: A first network entity for wireless communications, comprising at least one communication interface; and at least one processor coupled to the at least one communication interface, wherein the first network entity is configured to perform a method of any of aspects 18 through 34.

Aspect 39: An apparatus for wireless communications at a first network entity, comprising at least one means for performing a method of any of aspects 18 through 34.

Aspect 40: A non-transitory computer-readable medium having code for wireless communication stored thereon that, when executed by a first network entity, causes the first network entity to perform a method of any of aspects 18 through 34.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference is made to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
at least one communication interface; and
at least one processor coupled to the at least one communication interface, wherein the first network entity is configured to:
receive control information including an indication that a time interval is associated with subband full duplex communications for a second network entity, wherein the control information further includes an indication of a first set of frequency resources for the time interval associated with a first communication direction and a second set of frequency resources for the time interval associated with a second communication direction, and wherein the control information includes an indication that the time interval is associated with the first communication direction for the first network entity;
receive scheduling information for a first transmission between the first network entity and the second network entity in the time interval and the second set of frequency resources for the time interval, wherein the scheduling information includes an indication that the first transmission is associated with the second communication direction; and
communicate with the second network entity via the time interval in accordance with a conflict resolution scheme based on the time interval being associated with the first communication direction and the first transmission being associated with the second communication direction.

2. The first network entity of claim 1, wherein to communicate with the second network entity via the time interval, the first network entity is configured to:
communicate, in accordance with the conflict resolution scheme, the first transmission via the time interval and the second set of frequency resources.

3. The first network entity of claim 2, wherein the time interval comprises a flexible time interval type based on the first transmission being associated with the second communication direction in accordance with the conflict resolution scheme, and wherein the communication of the first transmission via the time interval and the second set of frequency resources is based on the time interval comprising the flexible time interval type.

4. The first network entity of claim 1, wherein to receive the scheduling information, the first network entity is configured to receive downlink control information including the scheduling information, and wherein to communicate with the second network entity via the time interval, the first network entity is configured to:
communicate, in accordance with the conflict resolution scheme, the first transmission via the time interval and the second set of frequency resources based on the downlink control information including the scheduling information.

5. The first network entity of claim 1, wherein the first network entity is configured to:
receive second scheduling information for a second transmission between the first network entity and the second network entity in the time interval and the first set of frequency resources for the time interval, wherein the second scheduling information includes an indication that the second transmission is associated with the first communication direction, and wherein, to communicate with the second network entity via the time interval, the at least one processor is configured to communicate one of the first transmission or the second transmission via the time interval in accordance with the conflict resolution scheme.

6. The first network entity of claim 5, wherein the first transmission comprises a first semi-statically scheduled transmission, wherein the second transmission comprises a second semi-statically scheduled transmission, and wherein, to communicate one of the first transmission or the second transmission via the time interval, the first network entity is configured to:
communicate, in accordance with the conflict resolution scheme, the second transmission based on the second transmission being associated with the first communication direction, the first transmission comprising the first semi-statically scheduled transmission, and the second transmission comprising the second semi-statically scheduled transmission.

7. The first network entity of claim 5, wherein the first transmission comprises a first semi-statically scheduled transmission, wherein the second transmission comprises a second semi-statically scheduled transmission, and wherein, to communicate one of the first transmission or the second transmission via the time interval, the first network entity is configured to:
communicate, in accordance with the conflict resolution scheme, whichever transmission of the first transmission and the second transmission that is associated with a higher priority level based on the first transmission comprising the first semi-statically scheduled transmission and the second transmission comprising the second semi-statically scheduled transmission.

8. The first network entity of claim 5, wherein the first transmission comprises a first semi-statically scheduled transmission, wherein the second transmission comprises a second semi-statically scheduled transmission, and wherein, to communicate one of the first transmission or the second transmission via the time interval, the first network entity is configured to:
communicate, in accordance with the conflict resolution scheme, the first transmission based on the second communication direction being associated with a higher priority than the first communication direction, the first transmission comprising the first semi-statically scheduled transmission, and the second transmission comprising the second semi-statically scheduled transmission.

9. The first network entity of claim 5, wherein the first transmission comprises a first semi-statically scheduled transmission, wherein the second transmission comprises a second semi-statically scheduled transmission, and wherein, to communicate one of the first transmission or the second transmission via the time interval, the first network entity is configured to:
communicate, in accordance with the conflict resolution scheme, the second transmission based on the first communication direction being associated with a higher priority than the second communication direction, the first transmission comprising the first semi-statically scheduled transmission, and the second transmission comprising the second semi-statically scheduled transmission.

10. The first network entity of claim 5, wherein the first transmission comprises a semi-statically scheduled transmission and the second transmission comprises a dynamically scheduled transmission, or wherein the first transmission comprises the dynamically scheduled transmission and the second transmission comprises the semi-statically scheduled transmission, wherein, to communicate one of the first transmission or the second transmission via the time interval, the first network entity is configured to:
communicate, in accordance with the conflict resolution scheme, the dynamically scheduled transmission based on the first transmission comprising the semi-statically scheduled transmission and the second transmission comprising the dynamically scheduled transmission or the first transmission comprising the dynamically scheduled transmission and the second transmission comprising the semi-statically scheduled transmission.

11. The first network entity of claim 5, wherein the first transmission comprises a semi-statically scheduled transmission and the second transmission comprises a dynamically scheduled transmission, or wherein the first transmission comprises the dynamically scheduled transmission and the second transmission comprises the semi-statically scheduled transmission, and wherein, to communicate one of the first transmission or the second transmission via the time interval, the first network entity is configured to:
communicate, in accordance with the conflict resolution scheme, the second transmission based on the second transmission being associated with the first communication direction and the first transmission comprising the semi-statically scheduled transmission and the second transmission comprising the dynamically scheduled transmission or the first transmission comprising the dynamically scheduled transmission and the second transmission comprising the semi-statically scheduled transmission.

12. The first network entity of claim 5, wherein the first transmission comprises a first dynamically scheduled transmission, wherein the second transmission comprises a second dynamically scheduled transmission, and wherein, to communicate one of the first transmission or the second transmission via the time interval, the first network entity is configured to:
communicate, in accordance with the conflict resolution scheme, one of the first transmission or the second transmission based on a timing order in which the scheduling information and the second scheduling information was received, the first transmission comprising the first dynamically scheduled transmission, and the second transmission comprising the second dynamically scheduled transmission.

13. The first network entity of claim 5, wherein the first transmission comprises a first dynamically scheduled transmission, and wherein the second transmission comprises a second dynamically scheduled transmission, wherein the scheduling information includes an indication of a first time domain resource allocation associated with the first transmission, wherein the second scheduling information includes an indication of a second time domain resource allocation associated with the second transmission, and wherein, to communicate one of the first transmission or the second transmission via the time interval, the first network entity is configured to:
communicate, in accordance with the conflict resolution scheme, one of the first transmission or the second transmission based on the first time domain resource allocation and the second time domain resource allocation, the first transmission comprising the first dynamically scheduled transmission, and the second transmission comprising the second dynamically scheduled transmission.

14. The first network entity of claim 1, wherein to receive the scheduling information, the first network entity is configured to receive radio resource control signaling including the scheduling information.

15. A first network entity for wireless communication, comprising:
at least one communication interface; and
at least one processor coupled to the at least one communication interface, wherein the first network entity is configured to:
transmit control information including an indication that a time interval is associated with subband full duplex communications for the first network entity, wherein the control information further includes an indication of a first set of frequency resources for the time interval associated with a first communication direction and a second set of frequency resources for the time interval associated with a second communication direction, and wherein the control information includes an indication that the time interval is associated with the first communication direction for a second network entity;
transmit scheduling information for a first transmission between the first network entity and the second network entity in the time interval and the second set of frequency resources for the time interval, wherein the scheduling information includes an indication that the first transmission is associated with the second communication direction; and
communicate with the second network entity via the time interval in accordance with a conflict resolution scheme based on the time interval being associated with the first communication direction and the first transmission being associated with the second communication direction.

16. The first network entity of claim 15, wherein to communicate with the second network entity via the time interval, the first network entity is configured to:
communicate, in accordance with the conflict resolution scheme, the first transmission via the time interval and the second set of frequency resources.

17. The first network entity of claim 16, wherein the time interval comprises a flexible time interval type based on the first transmission being associated with the second communication direction in accordance with the conflict resolution scheme, and wherein the communication of the first transmission via the time interval and the second set of frequency resources is based on the time interval comprising the flexible time interval type.

18. The first network entity of claim 15, wherein to transmit the scheduling information, the first network entity is configured to transmit downlink control information including the scheduling information, and wherein to communicate with the second network entity via the time interval, the first network entity is configured to:
communicate, in accordance with the conflict resolution scheme, the first transmission via the time interval and the second set of frequency resources based on the downlink control information including the scheduling information in accordance with the conflict resolution scheme.

19. The first network entity of claim 15, wherein the first network entity is configured to:
transmit second scheduling information for a second transmission between the first network entity and the second network entity in the time interval and the first set of frequency resources for the time interval, wherein the second scheduling information includes an indication that the second transmission is associated with the first communication direction, and wherein, to communicate with the second network entity via the time interval, the first network entity is configured to communicate one of the first transmission or the second transmission via the time interval in accordance with the conflict resolution scheme.

20. The first network entity of claim 19, wherein the first transmission comprises a first semi-statically scheduled transmission, wherein the second transmission comprises a second semi-statically scheduled transmission, and wherein, to communicate one of the first transmission or the second transmission via the time interval, the first network entity is configured to:
communicate, in accordance with the conflict resolution scheme, the second transmission based on the second transmission being associated with the first communication direction, the first transmission comprising the first semi-statically scheduled transmission, and the second transmission comprising the second semi-statically scheduled transmission.

21. The first network entity of claim 19, wherein the first transmission comprises a first semi-statically scheduled transmission, wherein the second transmission comprises a second semi-statically scheduled transmission, and wherein, to communicate one of the first transmission or the second transmission via the time interval, the first network entity is configured to:
communicate, in accordance with the conflict resolution scheme, whichever transmission of the first transmission and the second transmission that is associated with a higher priority level based on the first transmission comprising the first semi-statically scheduled transmission and the second transmission comprising the second semi-statically scheduled transmission.

22. The first network entity of claim 19, wherein the first transmission comprises a first semi-statically scheduled transmission, wherein the second transmission comprises a second semi-statically scheduled transmission, and wherein, to communicate one of the first transmission or the second transmission via the time interval, the first network entity is configured to:
communicate in accordance with the conflict resolution scheme, the first transmission based on the second communication direction being associated with a higher priority than the first communication direction, the first transmission comprising the first semi-statically scheduled transmission, and the second transmission comprising the second semi-statically scheduled transmission.

23. The first network entity of claim 19, wherein the first transmission comprises a first semi-statically scheduled transmission, wherein the second transmission comprises a second semi-statically scheduled transmission, and wherein, to communicate one of the first transmission or the second transmission via the time interval, the first network entity is configured to:
communicate, in accordance with the conflict resolution scheme, the second transmission based on the first communication direction being associated with a higher priority than the second communication direction, the first transmission comprising the first semi-statically scheduled transmission, and the second transmission comprising the second semi-statically scheduled transmission.

24. The first network entity of claim 19, wherein the first transmission comprises a semi-statically scheduled transmission and the second transmission comprises a dynamically scheduled transmission, or wherein the first transmission comprises the dynamically scheduled transmission and the second transmission comprises the semi-statically scheduled transmission, wherein, to communicate one of the first transmission or the second transmission via the time interval, the first network entity is configured to:
communicate, in accordance with the conflict resolution scheme, the dynamically scheduled transmission based on the first transmission comprising the semi-statically scheduled transmission and the second transmission comprising the dynamically scheduled transmission or the first transmission comprising the dynamically scheduled transmission and the second transmission comprising the semi-statically scheduled transmission.

25. The first network entity of claim 19, wherein the first transmission comprises a semi-statically scheduled transmission and the second transmission comprises a dynamically scheduled transmission, or wherein the first transmission comprises the dynamically scheduled transmission and the second transmission comprises the semi-statically scheduled transmission, and wherein, to communicate one of the first transmission or the second transmission via the time interval, the first network entity is configured to:
communicate, in accordance with the conflict resolution scheme, the second transmission based on the second transmission being associated with the first communication direction and the first transmission comprising the semi-statically scheduled transmission and the second transmission comprising the dynamically scheduled transmission or the first transmission comprising the dynamically scheduled transmission and the second transmission comprising the semi-statically scheduled transmission.

26. The first network entity of claim 19, wherein the first transmission comprises a first dynamically scheduled transmission, wherein the second transmission comprises a second dynamically scheduled transmission, and wherein, to communicate one of the first transmission or the second transmission via the time interval, the first network entity is configured to:
communicate, in accordance with the conflict resolution scheme, one of the first transmission or the second transmission based on a timing order in which the scheduling information and the second scheduling information was transmitted, the first transmission comprising the first dynamically scheduled transmission, and the second transmission comprising the second dynamically scheduled transmission.

27. The first network entity of claim 19, wherein the first transmission comprises a first dynamically scheduled transmission, and wherein the second transmission comprises a second dynamically scheduled transmission, wherein the scheduling information includes an indication of a first time domain resource allocation associated with the first transmission, wherein the second scheduling information includes an indication of a second time domain resource allocation associated with the second transmission, and wherein, to communicate one of the first transmission or the second transmission via the time interval, the first network entity is configured to:
communicate, in accordance with the conflict resolution scheme, one of the first transmission or the second transmission based on the first time domain resource allocation and the second time domain resource allocation, the first transmission comprising the first dynamically scheduled transmission, and the second transmission comprising the second dynamically scheduled transmission.

28. The first network entity of claim 15, wherein to transmit the scheduling information, the first network entity is configured to transmit radio resource control signaling including the scheduling information.

29. A method for wireless communications at a first network entity, comprising:
receiving control information including an indication that a time interval is associated with subband full duplex communications for a second network entity, wherein the control information further includes an indication of a first set of frequency resources for the time interval associated with a first communication direction and a second set of frequency resources for the time interval associated with a second communication direction, and wherein the control information includes an indication that the time interval is associated with the first communication direction for the first network entity;
receiving scheduling information for a first transmission between the first network entity and the second network entity in the time interval and the second set of frequency resources for the time interval, wherein the scheduling information includes an indication that the first transmission is associated with the second communication direction; and
communicate with the second network entity via the time interval in accordance with a conflict resolution scheme based on the time interval being associated with the first communication direction and the first transmission being associated with the second communication direction.

30. A method for wireless communications at a first network entity, comprising:
transmitting control information including an indication that a time interval is associated with subband full duplex communications for the first network entity, wherein the control information further includes an indication of a first set of frequency resources for the time interval associated with a first communication direction and a second set of frequency resources for the time interval associated with a second communication direction, and wherein the control information includes an indication that the time interval is associated with the first communication direction for a second network entity;
transmitting scheduling information for a first transmission between the first network entity and the second network entity in the time interval and the second set of frequency resources for the time interval, wherein the scheduling information includes an indication that the first transmission is associated with the second communication direction; and
communicating with the second network entity via the time interval in accordance with a conflict resolution scheme based on the time interval being associated with the first communication direction and the first transmission being associated with the second communication direction.
